(19) United States
(12) Patent Application Publication
(10) Pub. No.: US 2010/0049647 A1
(43) Pub. Date: Feb. 25, 2010

(54) FINANCIAL SECURITY AND A TRANSACTION METHOD, SYSTEM AND INDEX RELATING TO THE SAME

(76) Inventor: Andrew Marks De Chabris, Toronto (CA)

Correspondence Address: HOFFMANN & BARON, LLP, 6900 JERICHO TURNPIKE, SYOSSET, NY, 11791, US

(21) Appl. No.: 12/543,112

(22) Filed: Aug. 18, 2009

(30) Foreign Application Priority Data
Aug. 19, 2008 (CA) 2638893

(51) Int. Cl. G06Q 40/00

(52) U.S. Cl. 705/37

(57) ABSTRACT

A tradable security comprising a voting right associated with an underlying financial security and an instrument for permitting at least said voting right to be separated from at least some residual rights in the underlying financial security to create a voting right security wherein the ownership and control of the voting right security is tradable separate from the residual rights in the underlying security to permit a value of said voting right security to be established in an open market. In another aspect the invention is directed to a method of creating such a voting right security. In another aspect the invention is directed to a method of clearing and setting trades of the voting right security. In another aspect the invention is directed to a method of creating an index from the voting right security.

### CROSS-REFERENCE TO RELATED APPLICATIONS

This application claims priority to Canadian Patent Application No. 2,638,893, filed Aug. 19, 2008, the entire contents of which are hereby incorporated by reference.

### FIELD OF THE INVENTION

This invention relates generally to the field of financial instruments and more particularly to financial instruments of the sort that can be exchanged or traded for money. Most particularly this invention relates to a new form of tradable right related to share equity.

### BACKGROUND OF THE INVENTION

Common equity securities, frequently called “shares of common stock” or “equities”, are often considered a basic class of investment instrument. However shares of common stock are comprised of a bundle of rights owned by the equity or share holder, such as the right to all capital gains and losses, the right to receive dividends and the right to the residual value of the corporation upon liquidation after all debt holders have been repaid. Another key right that often belongs to the common equity holder is the right to vote on corporate issues such as appointment of directors, approval of mergers and any other issues that require a shareholder vote in accordance with the governing shareholder agreement.

Share ownership and exercising the rights accruing to share owners is facilitated by brokerage firms, banks, custodians, wagering firms, and other financial institutions, (collectively “Financial Firms”). For example, when there are matters on which the holder of an equity security is entitled to vote then typically the corporate issuer of the security (the “Issuer”) transmits the information relevant to the vote to its transfer agent/registrar. The transfer agent/registrar has a record of all registered holders of the shares and can thus pass along the information to the recorded shareholders either directly or via the Financial Firms where the shares are held.

The shares or securities may be recorded in the owner's name by electronic registration with the registrar/transfer agent. They may also be held by Financial Firms who register their clients equity securities at the transfer agent/registrar “in street name”, eg. in the name of the Financial Firm who in turn records within its own internal records the names of its clients who are the holders of the securities and the quantities held. Financial Firms and transfer agents forward the voting related information to the shareholders. Currently used systems for trading, processing, clearing and settlement of equity securities handle the voting rights as an integral, inseparable and indivisible feature of the underlying shareholding.

When an owner of shares exercises their voting rights there are several means for communicating the share vote to management. The shareholder may participate directly in a company meeting where a vote count is carried out. Alternatively, a proxy form may be submitted to the Financial Firm, where the shareholder has an account, which verifies the number of votes against the number of shares of that particular equity security in the owner's accounts at the Financial Firm, then tallies the total of different votes across all its clients and submits this information to the Issuer or the Issuer's registrar/transfer agent. Often third party systems are used to pass the voting related background information from the registrar/transfer agent to the Financial Firms, and to pass the shareholding and voting totals from the Financial Firms back to the registrar/transfer agent. An owner may submit its paper voting proxy form directly to the Issuer or its transfer agent.

When a group of shareholders decides that they wish to act in concert they may negotiate amongst themselves the terms and conditions of a private voting trust whereby each member of the group agrees to exercise their share voting rights according to some agreed to decision-making process. That process may be simply to follow the voting intent of the lead shareholder of the group, or can be more involved, such as voting in accordance with the majority decision within a voting trust group. The voting trust exercises power of attorney over the voting rights of the members of the trust so it submits one set of voting decisions for all the shares it controls to the registrar/transfer agent. The core intent is to ensure that by acting collectively the group maintains sufficient voting power to influence management of the Issuer. A different strategy with similar intent that is often used by founding shareholders in Canada is to issue themselves shares with multiple voting rights. New shareholders receive single voting or non-voting shares. The result is that a relatively small percentage economic ownership still allows them voting control or substantial influence of the Issuer.

Several challenges confront the securities industry in jurisdictions in which shares of stock possess voting rights. Individual shareholders with relatively small individual holdings, as well as occasionally those who control large shareholdings, of an Issuer of stock often do not exercise their right to vote on issues that are put to shareholders. Alternatively they simply vote in line with the default recommendation that the current management of the corporation suggests. Among the reasons generally attributed for this phenomenon are: shareholder lethargy, lack of time to assess the issues and formulate a consistent response, inability to forecast the outcomes of different choices on the Issuer's business and stock price, and the challenges of assigning probabilities for each of the various potential outcomes. With this amount of complexity and the inherent bias of management in presenting one set of proposals for consideration it is not surprising that many shareholders treat the exercise of their voting rights with a fair degree of indifference.

Brokerage firms' research is typically used to both increase trading revenues from clients that use the research, and to support investment banking business services being provided to an Issuer. When clients of brokerage firms do not exercise their stocks' voting rights then the regulatory regime often permits the brokerage firms to vote the voting rights according to its own policies by submitting its voting elections to the transfer agent/registrar or directly to the Issuer. In the past many brokerage firms voted in line with Issuer's management's proposals to encourage the receipt of investment banking assignments from the Issuer, and to encourage the Issuer to continue to grant access to senior management of the Issuer for the brokerage firm's research analysts. This conflict of interest has promoted regulatory changes, including the Sarbanes-Oxley Act in the United States, with laws that seek to prevent brokerage firms from using their research departments as marketing arms for their corporate financing activities. These changes have increased the impact and importance and care required of brokerage firms in voting of shares that are really owned by their clients.

Investment management firms and/or brokerage firms can have power of attorney over client investment accounts, and often control enough shares this way to influence the outcome of a vote. In the past, such firms may have voted in their own interest rather than in the best interests of their own clients. Frequently they have preferred to take a passive approach by voting in the way recommended by management or to sell their shareholding if they do not agree with actions of management.

Now, due to legislation in the United States, they are more likely to retain a third party research firm to assess voting alternatives and to provide a recommendation. The investment management firm then can vote the shares that the firm controls in line with the research company's recommendation. The drawback to this approach is that there are only a few research firms with the scope to cover most of the equity investment universe of the investment management firms, so the potential for conflicts of interest arise due to the immense influence these research firms possess. This influence comes without the same regulatory oversight that constrains research done in house by investment brokerage firms or by credit rating agencies.

Although the third party research firms are supposed to be impartial they are not prohibited from marketing their services to the Issuers, whose proposals are being put to shareholder vote, and which are being assessed by the research firms for their investment management clients. In a similar context to credit rating agencies, the ability of these third party research firms to provide objective advice is in part linked to their deriving the greater portion of their revenues from analysis buyers compared to revenues from those being analyzed.

This independent research approach also does not necessarily maximize shareholder value because among other things different shareholders define maximum value in different ways. Some investors may seek the greatest returns while others may seek reduced risk. Furthermore the shareholders may be in different positions. One investor's exposure to the stock may be modified by derivatives, such as the purchase of a put to insure against decline or increased volatility, whereas as another may not be so insured. The insured portfolio has an incentive to vote for initiatives that increase volatility of earnings, whereas a portfolio which has increased its risk exposure in return for an income stream, eg. written calls, will be biased towards reducing earnings volatility. In summary it is all too likely for the voting rights associated with shareholdings to be either under valued and disregarded by their true owners, or exercised in a suboptimal manner by their designees.

In addition to the foregoing, which applies to widely held securities, it may be the case that the share ownership is not widely held. A few founders or a voting trust may have a majority of the voting rights, meaning, minority shareholders have little influence except to the extent that protection for minority shareholders exists at law. Also common is where founders or a voting trust has an influential but sub-majority voting position. The average shareholder rarely has either access to multiple voting shares, or a forum outside of the voting process to form a significant voting group. Therefore, such small stake holder or minority shareholders have a reduced incentive to vote, especially in those situations where their collective votes can be disregarded.

Other ways of owning investments also creates problems. For example, mutual funds' investment behaviors are significantly driven by internal review and compensation schemes that focus on the quarterly results for their portfolios. Whether they have a short or a long term investment style they often have a bias towards voting for initiatives which they perceive will bring quicker returns. In contrast, investors that have inherently long investment horizons due to their planning objectives, such as is often the case with pension funds, insurance companies and family offices, often have a bias towards voting for initiatives that they feel will bring greater long term returns and potential for the business. Retail investors are more likely to have investing/planning time horizons that sit in the middle ground between these two groups.

The specific names or memberships of the groupings of these investors are not as important as the fact that their investment time horizons will often be significantly different. Dependent on the predominance of one group and its time horizon, proposals will be approved via the voting process that may provide more value to the predominant group and less value to members of the other groups of shareholders during their relevant holding period. The only method that currently exists for a shareholder with a specific investment horizon to resolve this problem is to only invest in companies whose shareholders predominantly have the same investment horizon. This method is very inefficient as it would substantially reduce the investment universe and diversification potential for each shareholder group, as well as introduce severe, undesirable stock selection bias for each investor.

Another challenging issue for equity investors is the presence of a class of equity investor that is able to obtain ancillary benefits, aside from those as a shareholder, from the Issuer when certain types of proposals are approved and implemented by management. Strategic investors may be able to position themselves to leverage capabilities of the Issuer for their own business in a manner that a regular shareholder cannot.

An example is a manufacturer taking a stake in a distributor to ensure access to the distributor's sales and marketing channel that provides direct benefit to the manufacturer. Another example is a private equity investor with a portfolio of companies may push the management of investee companies to come up with proposals that help the private equity investor find synergies to extract maximum value from its portfolio mix of companies. Similarly, a large creditor of a leveraged Issuer that is also a significant shareholder may have a vested stake in influencing the Issuer to reduce leverage. The potential reduced returns to shareholders would benefit the creditor by reducing its downside risk on its loan to the Issuer. Alternatively an opportunistic, large creditor that is also a significant shareholder may swing the vote for management proposals of higher leverage knowing that it is best positioned to take control of the company should it go into bankruptcy.

None of these last few circumstances encourage management to generate proposals that seek maximum value for the Issuer and its average, small shareholder, let alone guarantee it. In the light of all these issues it is not surprising that the process of exercising an investor's voting rights is not an effective means of maximizing the value of their investment. A corollary to this situation is that investors do not exercise their voting rights, or do so in a sub-optimal fashion. Accordingly it is felt that there is an unmet need for processes, methods and means embedded in financial management systems for implementing the efficient allocation of voting rights within the capital markets.

### SUMMARY OF THE INVENTION

The voting process involves a number of steps, entities and interacting systems. What is needed is a solution to the problems faced by voting shareholders which is also attractive to the industry participants so they will be incented to participate in the solution. Voting rights are best held by an entity which has the wherewithal and motivation to conduct thorough and non-conflicted due diligence and enough votes to exercise the voting rights in a meaningful way. Smaller investors need an incentive for making the voting rights available to be exercised in this way. A tradable instrument is required to allow this to be achieved. A set of systems and processes are required to support the instrument.

The present invention comprehends investor participation in a market for securities that primarily or exclusively represent the value of voting rights in a corporation(s). This is referred to herein as a voting right security (VRS). Thus, according to a first aspect of the present invention there is provided a tradable security comprising:
a voting right arising from an underlying financial security, and
an instrument for permitting said voting right to be separated from said underlying financial security to create a voting right security, said financial security having voting rights and residual rights, wherein ownership and control of said voting right security is tradable separate from ownership of at least some of said residual rights of said underlying financial security to permit a value of said voting right security to be established in an open market. The underlying financial security is typically voting equity shares issued by a corporation (“Equity Issuer”).

The financial management and processing systems according to the present invention enable a range of services relating to the new form of security including: i) creation of such securities; ii) processing of completed purchase and sale transactions and tracking holdings; iii) communicating voting related information; iv) distributing and reporting transaction information; v) evaluating opportunities amongst such securities and analyzing portfolio impacts; and vi) guaranteeing payments and fulfillment of voting elections.

In the context of this application any network, location, market, exchange or process wherein buyers and sellers can be brought together, physically or electronically, in order to agree to or complete transactions of purchase or sale of VRS, of derivative contracts on VRS, of derivative contracts on an index of VRS is an exchange (“Exchange”). Thus exchanges, ECNs, trading desks and matching systems are examples.

In the preferred embodiment a clearing corporation for VRS (“VRS Clearing Corporation” or “VRCC”) is the counterparty to all Exchange trades of VRS and brokers that are authorized to clear and settle trades in VRS with the VRCC are Clearing Member Brokers (“CMB”).

Therefore according to another aspect the present invention provides a method of clearing and settling a voting right security trade which has been made by a broker on an Exchange for such trades, the method comprising:
separating a voting right arising in relation to a financial security from the ownership of the underlying financial security to create a tradable voting right security (“VRS”),
registering the particulars of the VRS with a Transfer agent/Registrar and a VRCC,
trading said VRSs on said Exchange,
communicating certain particulars of said Exchange trades of said VRSs to said VRCC at the end of each trading period, including the Equity Issuer over which the voting rights apply, the expiration date or term to expiration of said voting rights, any delayed commencement of said voting rights, whether the sale was of an existing position or the initiating sale to create a new VRS position,
computing the sum of the trades of each broker at the VSR clearing corporation to determine any outstanding balances owing at the end of the trading period,
communicating the sum of the transactions at the end of the trading period from the VRCC to the Transfer agent/Registrar, and
settling the outstanding balances between the VRCC and the CMBs.

The present invention is directed to a method of creating securities which represent a clear expression of the value of the voting rights of an Issuer, and a means of implementing and tracking in accounts at financial services firms the holdings in these securities and processing the transactions in these securities both in and between financial services firms. The result enables holders of voting rights to transfer these rights by creating the requisite supporting processes, and thus provide those holders with the choice of selling these rights, or buying more rights in an efficient, cost effective manner.

Therefore according to an additional aspect of the present invention there is provided a data processing system for administering a tradable voting right security which comprises only the right to vote in an issuer's shareholder vote, the data processing system comprising:
computer means for recording the particulars of the voting right security,
data entry means for entering sufficient particulars of any trades of the voting right security in a trading period to permit a computation of both the net and the sum of all trades made by traders in said voting right securities at the end of the trading period;
data computational means to permit said trading of said voting right securities to be netted and summed at the end of each trading period to determine any outstanding balances receivable or payable owed at the end of the trading period relative to said trades; and
communication means to communicate the outstanding balances to the traders and the resultant positions in said voting right securities to a transfer agent/registrar.

Accordingly the present invention is broadly directed to a method of implementing, supporting, engendering and processing transactions in voting right securities that when traded provide a market value for the voting rights of an Issuer. The result is a functional environment and support for a market that enables holders of voting rights to value these rights. This in turn provides them with both the information and capability to make the choices of selling these rights, buying more rights, or maintaining the status quo.

The present invention also provides transactions processing mechanisms that are required to support trading and price discovery in this unique class of security. These are comprised of processes and/or software that include:
a) structuring and originating such VRS securities as well as derivatives contracts upon such VRS or upon any index of VRS or directly upon underlying voting rights of voting shares;
b) tracking and margining positions in, as well as processing and clearing of transactions in, these VRS securities and shares of stock for which control of the voting rights have been shifted to a third party;
c) reporting the voting elections of owners of the such VRS securities to the Financial Firms holding the VRS owners' positions or to such other parties that play a role in communicating said VRS votes to the relevant Equity Issuer (reporting information on the VRS positions and/or the voting elections of clients of Brokers to their VRS Clearing Member Brokers; reporting said information of clients of CMBs and of their Broker customers to VRCC; reporting said information by VRCC or other party to either the Transfer Agent/Registrar or to the Equity Issuer);
d) reporting, aggregating and distributing transaction data related to trading activity in such VRS securities [including any of bid, bid size, offer, offer size, trade price, or volume, expiration date, delayed activation of voting rights, the related Equity Issuer], including creating indices based in whole or part thereon;
e) analyzing and assessing the impact of transactions in such VRS securities on individual equities holdings and portfolio holdings;
f) clearing corporation processes in which VRCC, as principal, is counterparty to every trade and thereby guarantees payments and fulfillment of exercise of rights that form the core of such VRS securities, in particular that the owners of voting shares that created VRS, thereby encumbering the voting shares, have not exercised their voting rights or made elections during the period of time that the VRS on said shares are in existence and have active voting rights; and
g) guarantor processes in which VRCC, as guarantor, ensures fulfillment of exercise of rights that form the core of such VRS securities, in particular that the owners of voting shares that created VRS, thereby encumbering the voting shares, have not exercised their voting rights or made elections during the period of time that the VRS on said shares are in existence and have active voting rights.

In a further aspect the present invention comprehends the calculation, preparation and publication of an index comprised of a quantity derived as a direct or indirect measure of a value of at least one VRS as determined through trading on an Exchange.

### BRIEF DESCRIPTION OF THE DRAWINGS

Reference will now be made to various aspects of the present invention, by way of example only, in respect of the following figures:

FIG. 1 shows creating Issue Controlled Voting Contracts by shifting control over voting rights of underlying shares of Equity Issuer according to an aspect of the present invention;

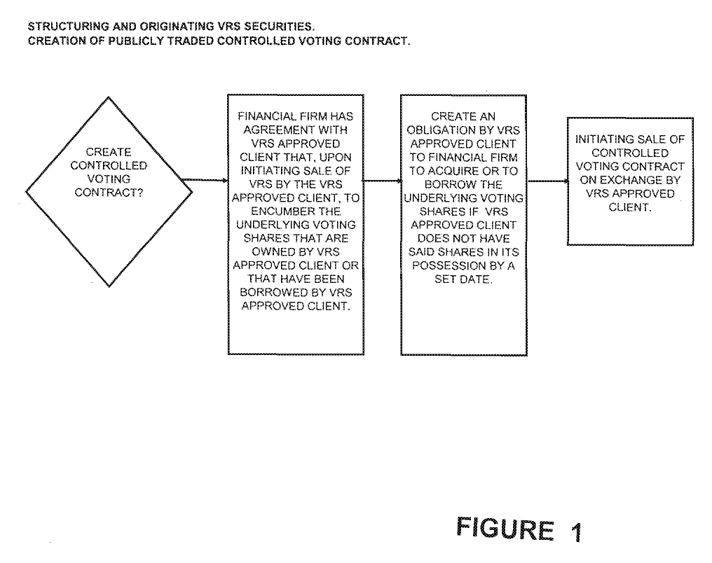

FIG. 2 shows creating Issue Voting Rights Contracts by separating voting rights from underlying shares of Equity Issuer;

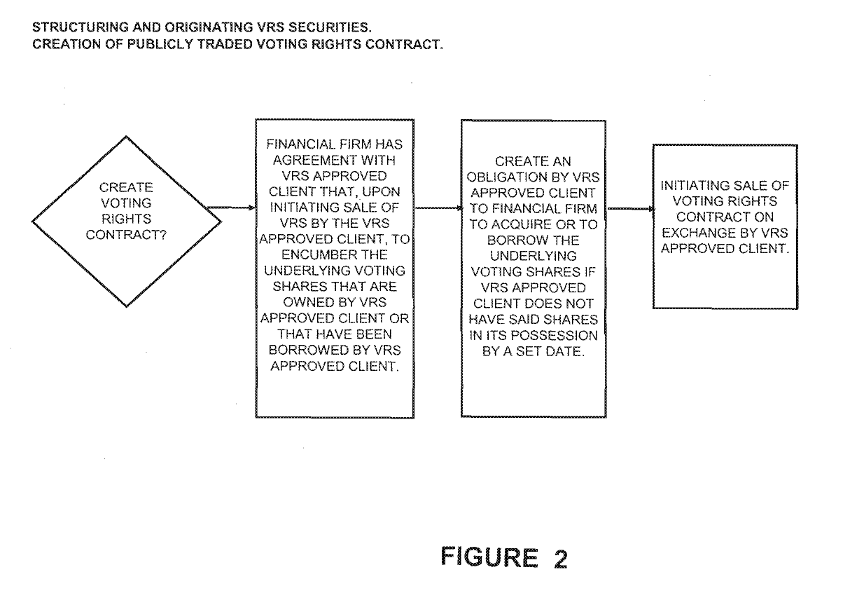

FIG. 3 shows the creation of publicly traded Voting Rights Shares, of Voting Rights Units, or of Voting Rights Partnership Units through creation of special purpose entity;

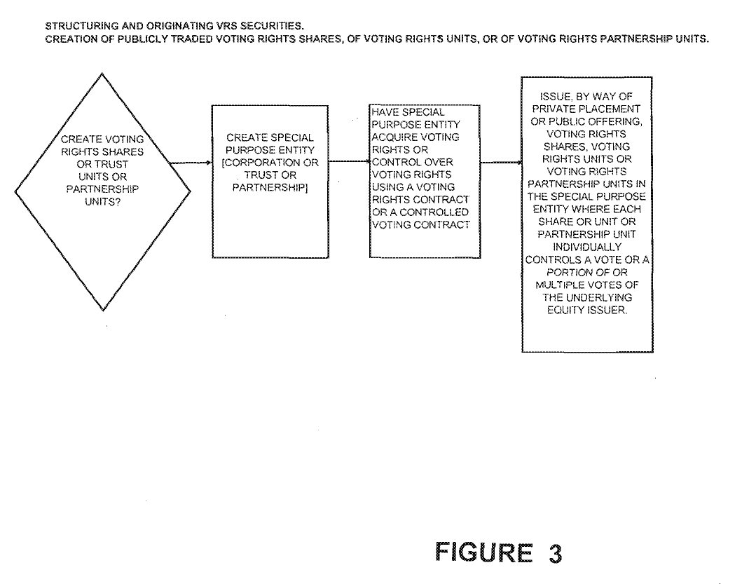

FIG. 4 shows the creation of VRS principal protected notes;

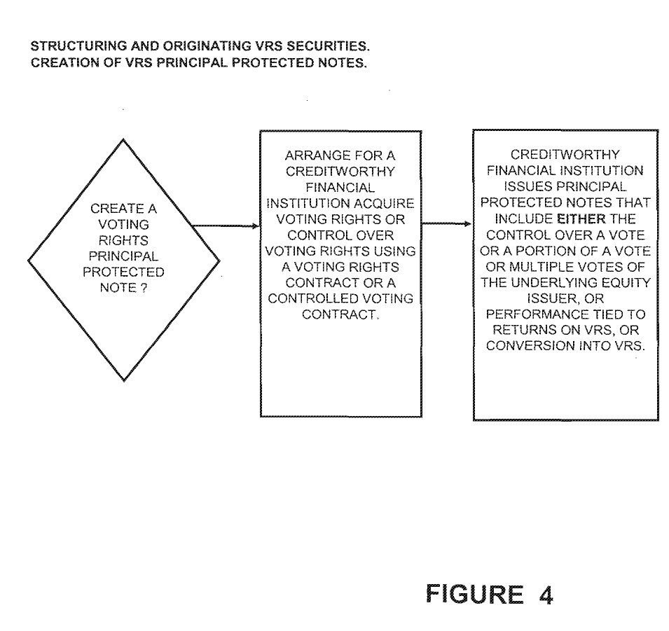

FIG. 5 shows the creation of OTC VRS Derivative;

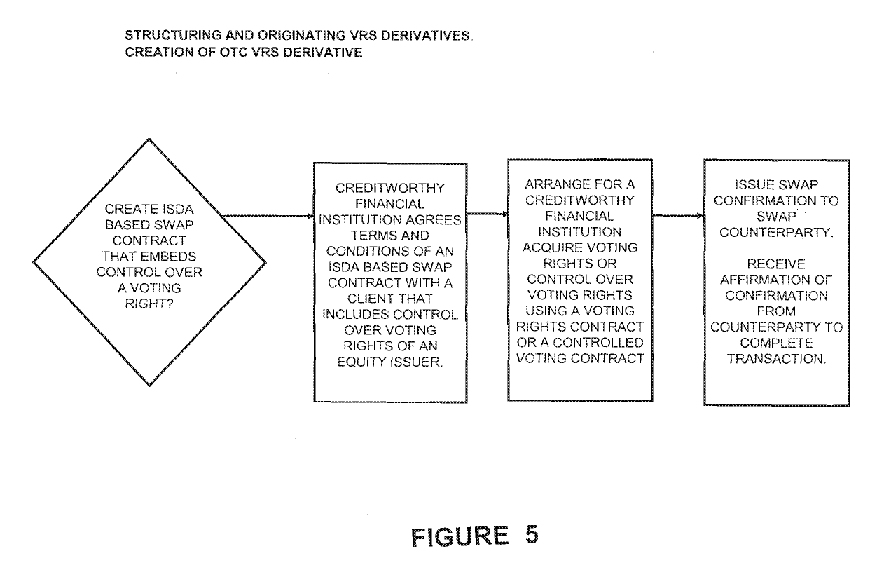

FIG. 6 shows the creation of VRS Wager;

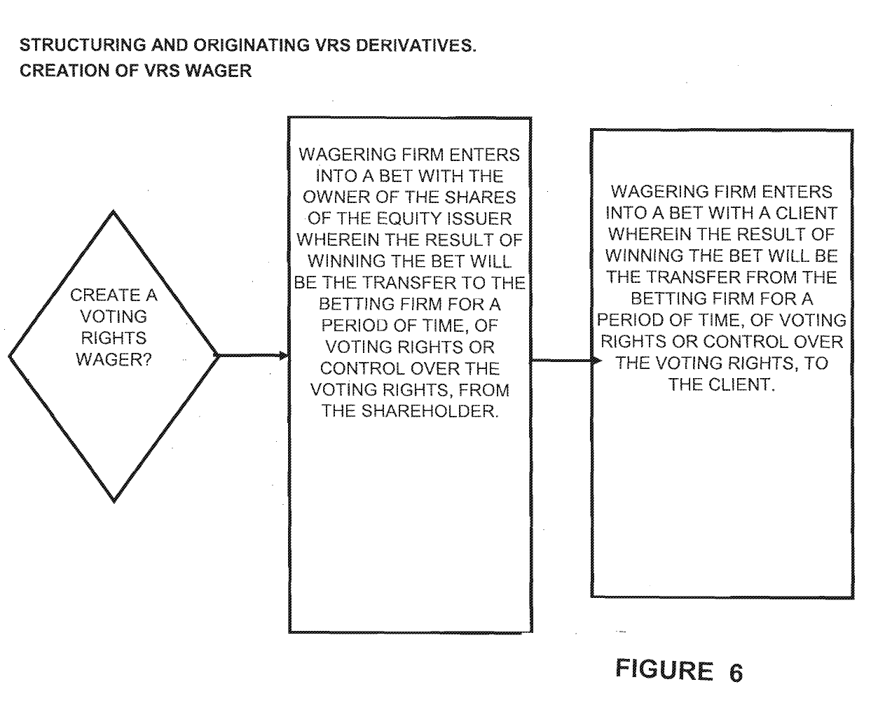

FIG. 7 shows the manual or automatic management of client VRS & margin account collateral; financial firm creation of reports and datafiles of VRS trades and VRS related positions;

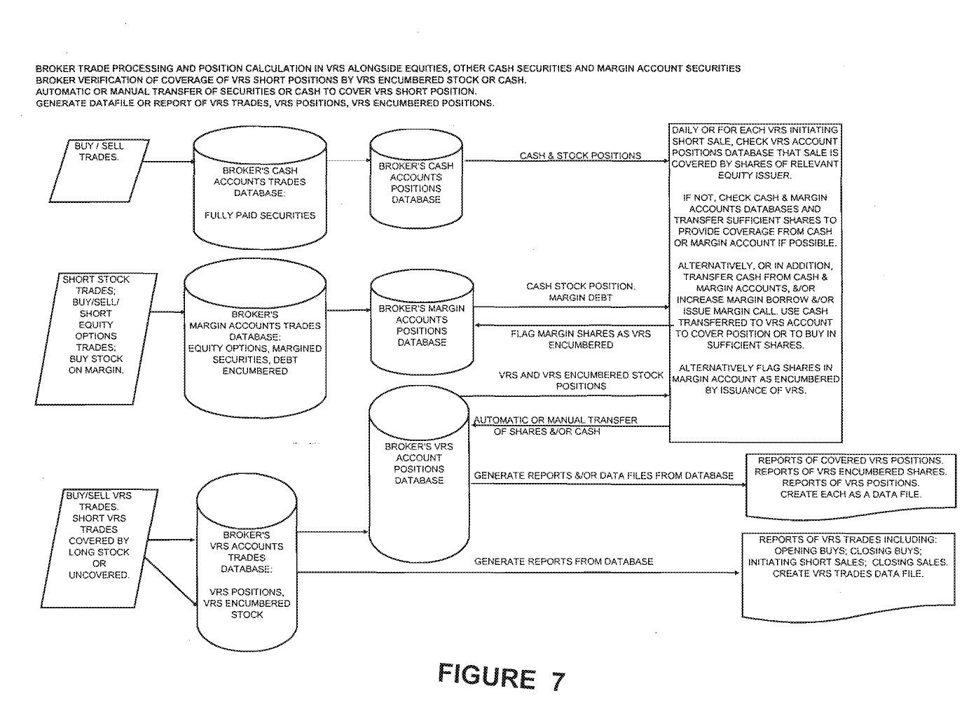

FIG. 8 shows VRS encumbered positions are marginable, set margin rates and margin loan-to-value for VRS; apply margin rates and margin loan-to-value ratio;

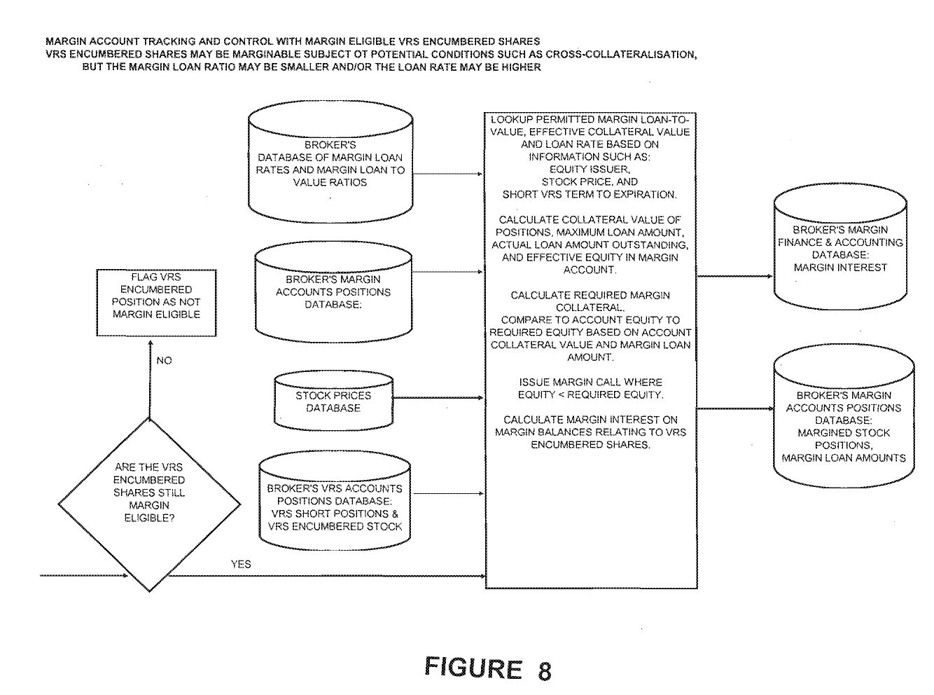

FIG. 9 shows an update database of VRS and their standardised terms and conditions. Generate a list of eligible VRS used to accept or reject trades;

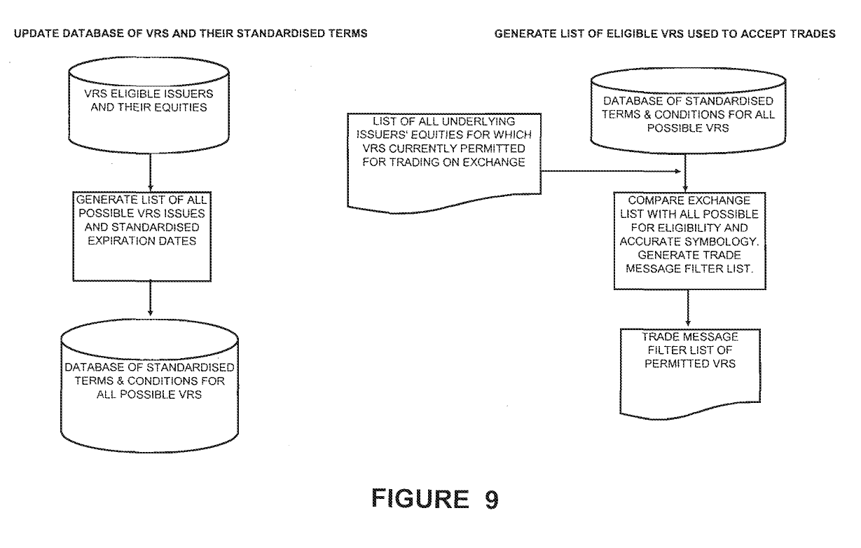

FIG. 10 shows compliance verification for VRS client applications. Update VRS Approved Client details & account number in VRS Approved Client & Trades & Positions databases;

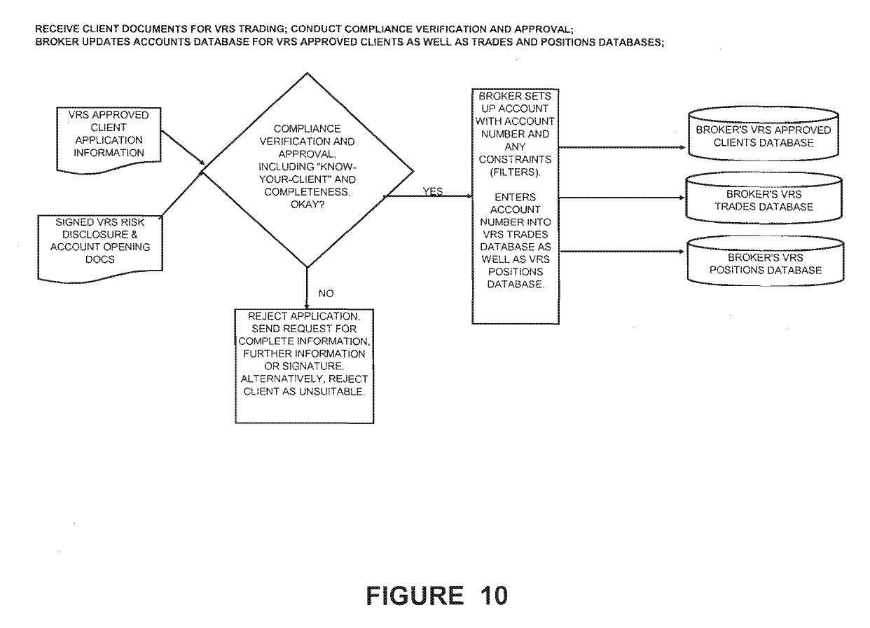

FIG. 11 shows broker or CMB provides list of VRS Approved Clients to Executing Broker's database. Trading platform checks that VRS trade order messages are from permitted Approved Clients;

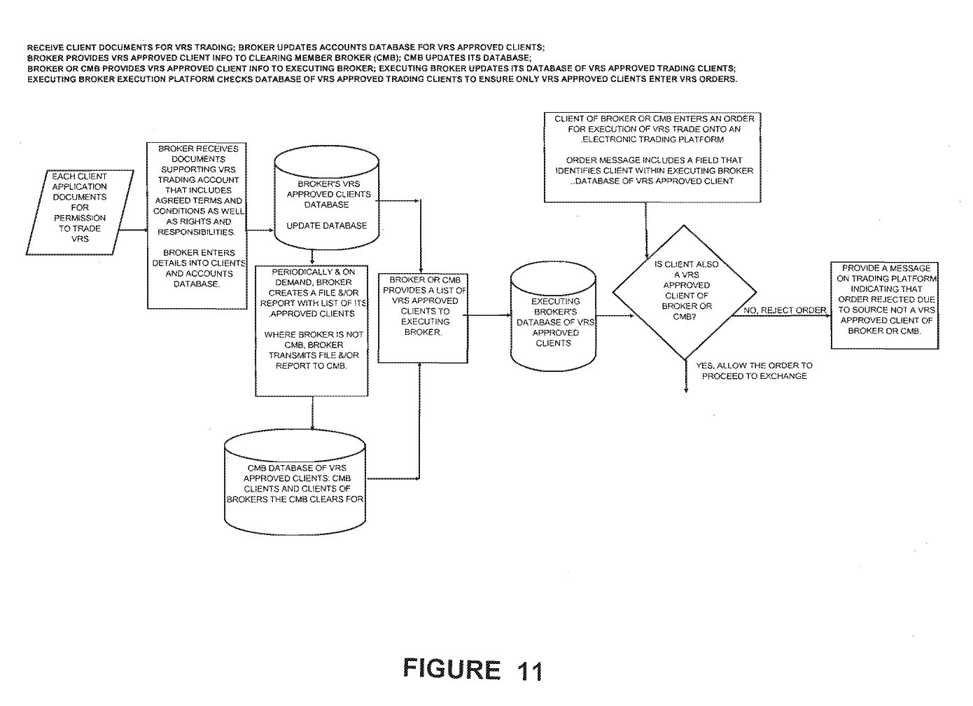

FIG. 12 shows how VRCC accepts/rejects trade messages from CMBs based on: i) from permitted CMB; ii) permitted VRS; iii) trade size<=VRS trade limit.

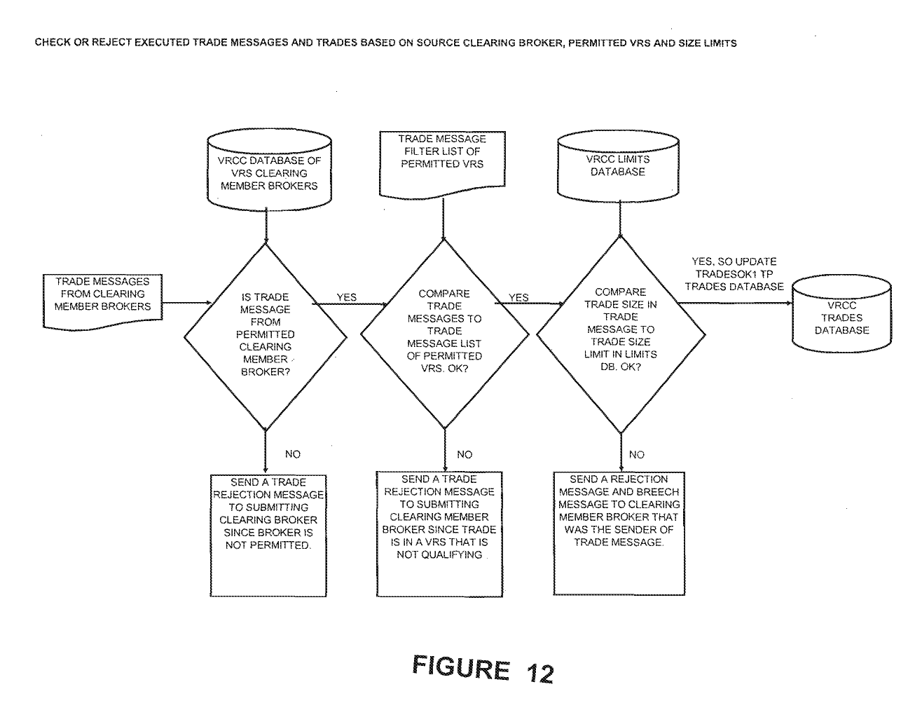

FIG. 13 shows how VRCC creates VRS upon affirmation & settlement of initiating VRS short sale. Affirm & settle long sales, opening buys & closing buys. Log trades as affirmed in Trades Database;

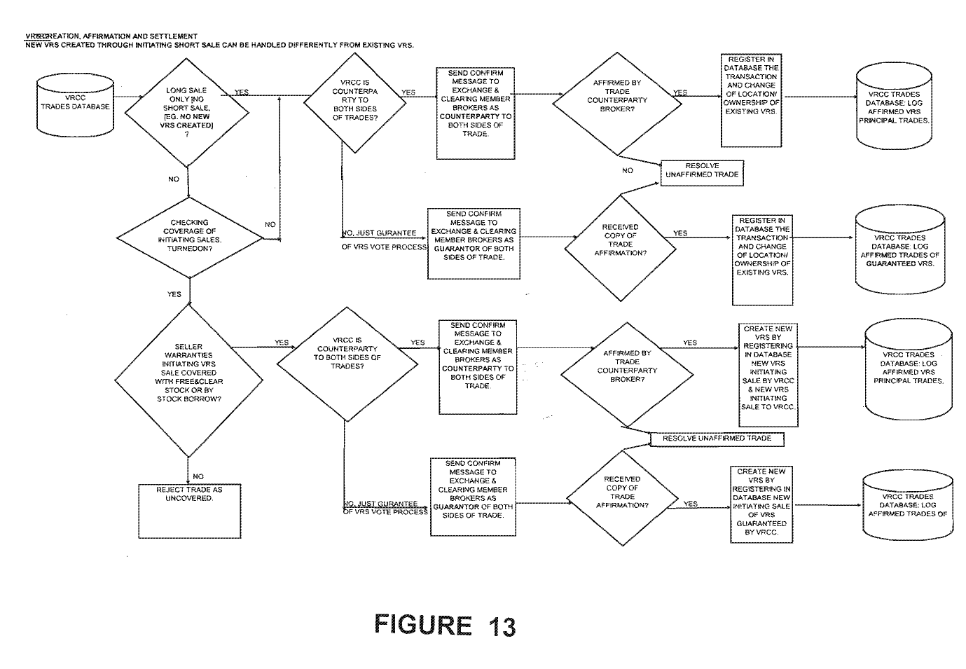

FIG. 14 shows how VRCC calculates settlement balances from trade totals, compares VRCC net aggregates to CMB amounts, checks that all CMB trade balances reconcile;

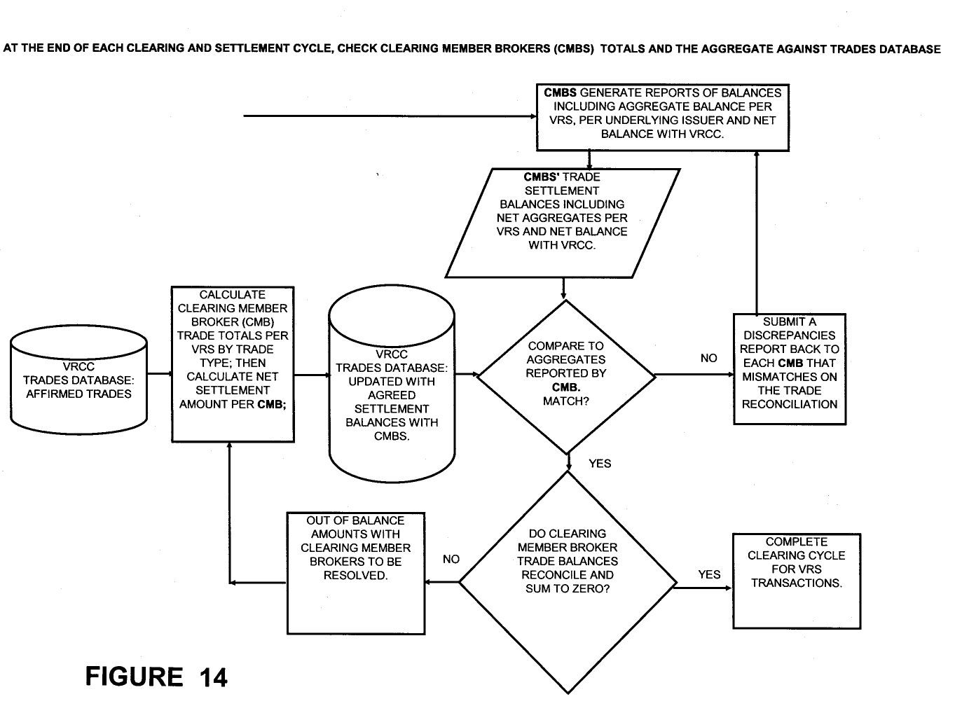

FIG. 15 shows where VRCC is principal to every VRS transaction, carry out accounting and finance functions, send each CMB its closing balance payable/receivable, manage cash.

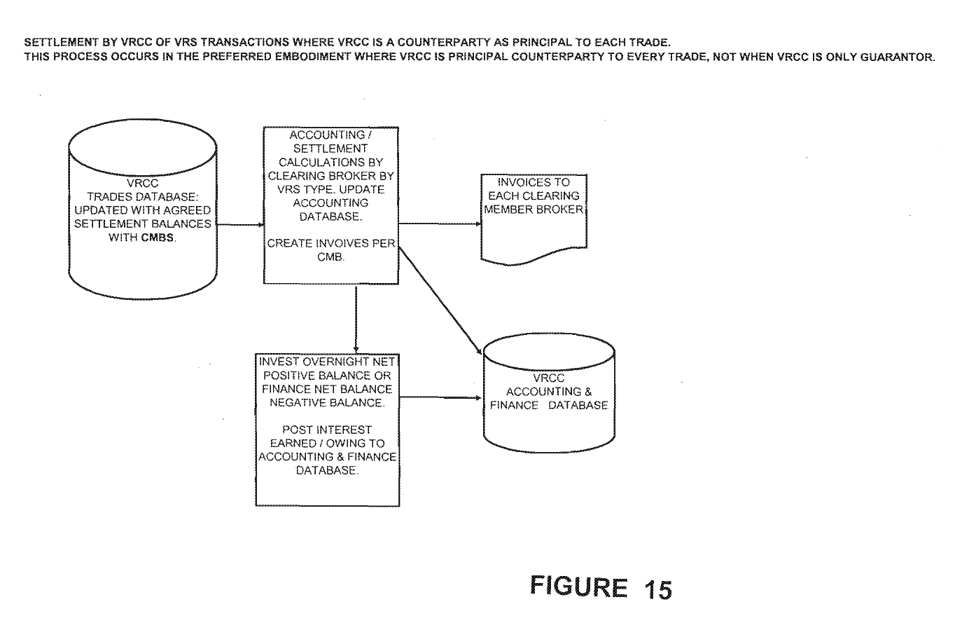

FIG. 16 shows Update Positions Database with initiating sales & corresponding buys, as well as existing VRS buys & sells;

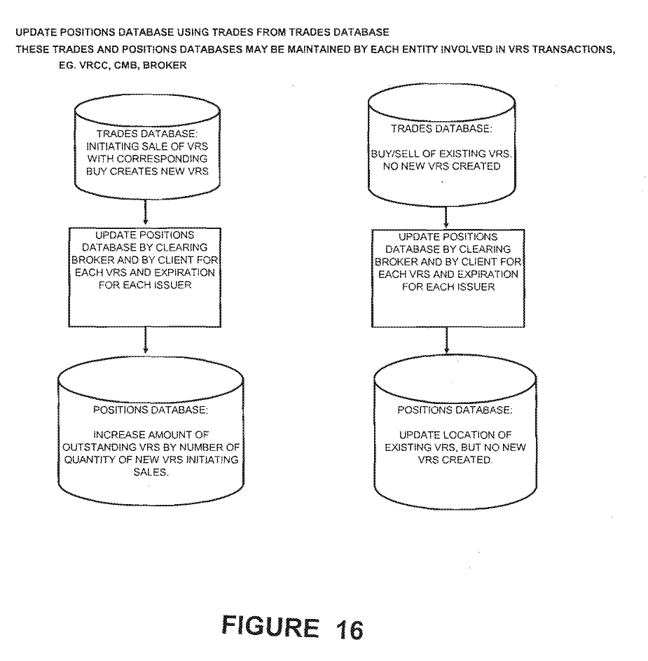

FIG. 17 shows generate warnings based on various breaches of limits from Limits Database. Flag any breaching positions with each breach within Positions Database;

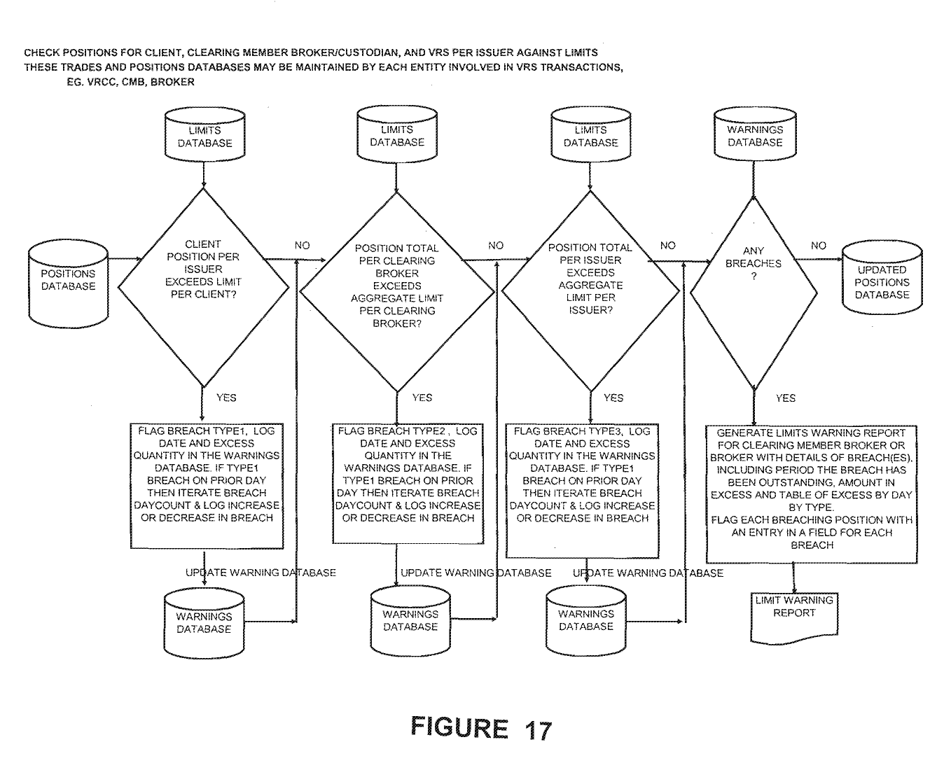

FIG. 18 shows Generate various VRS positions reports &/or datafiles for each CMB using Positions Database;

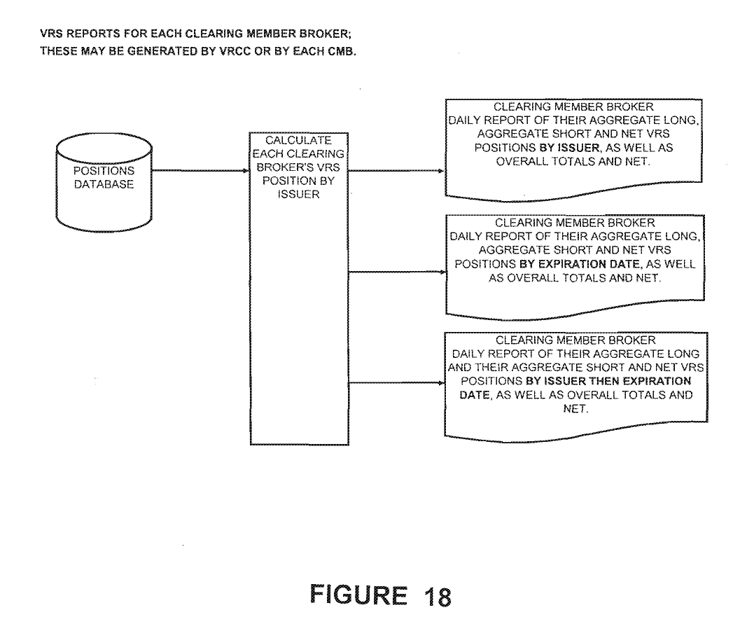

FIG. 19 shows Generate various VRS positions reports &/or datafiles for each Transfer Agent/Registrar using Positions Database and Equity Issuers Database

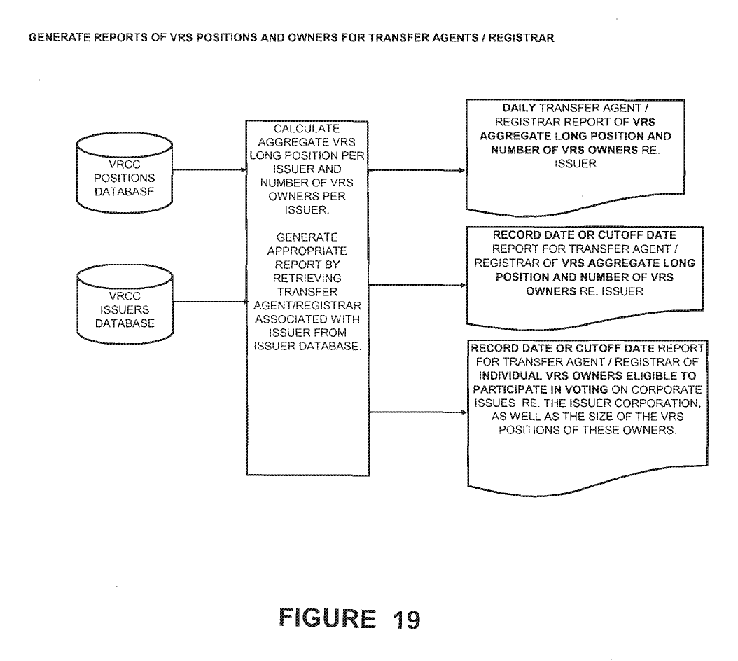

FIG. 20 shows the process whereby Financial Firms forward printed and electronic documents from Equity Issuer to CMB and in turn to VRCC where client's shares are encumbered by VRS issuance.

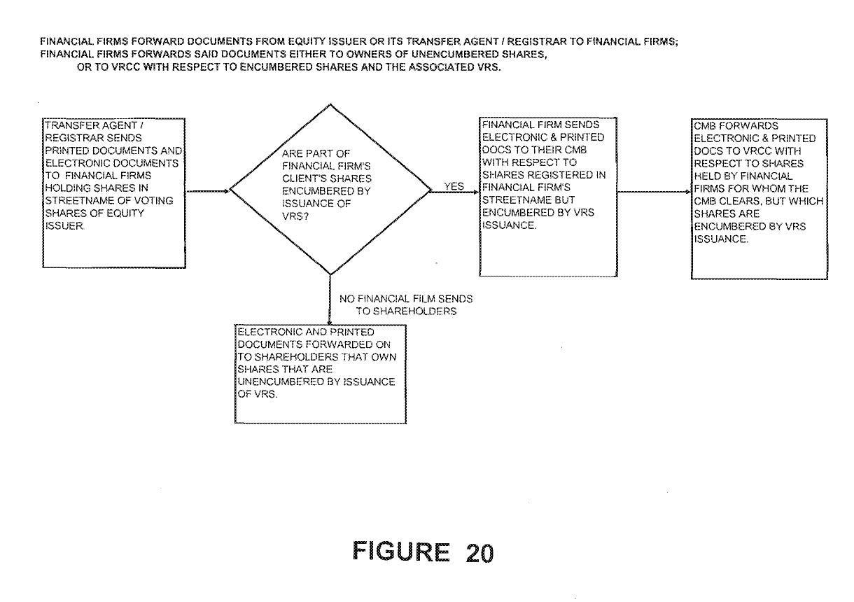

FIG. 21 shows VRCC forwards printed and electronic documents from Equity Issuer to CMBs whose clients or their customer Brokers' clients have long VRS positions related to Equity Issuer;

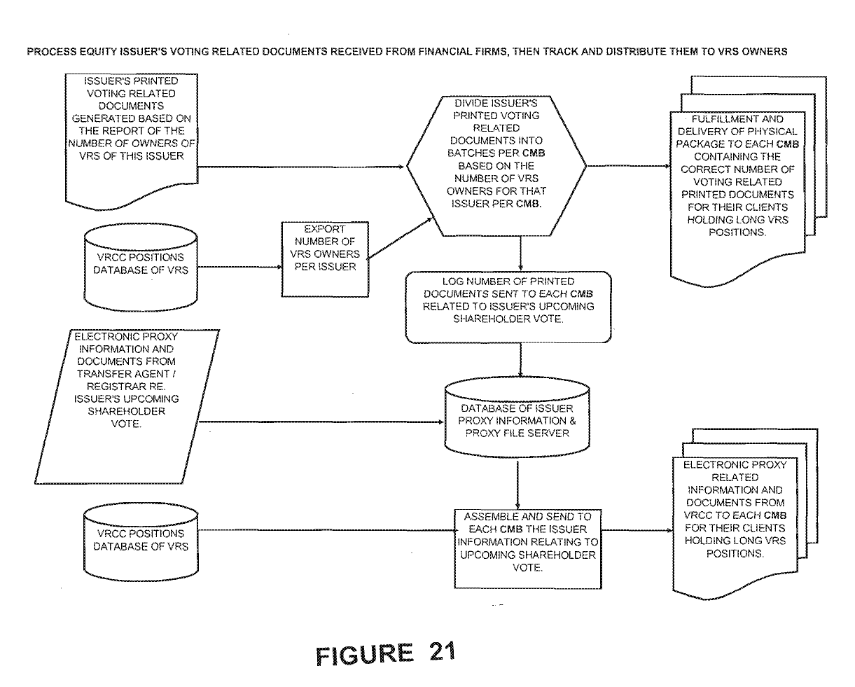

FIG. 22 shows Broker receives elections related to long VRS & updates Votes Database. Checks if VRS direct votes & VRS submitted votes<=VRS position. CMB aggregates & sends to VRCC;

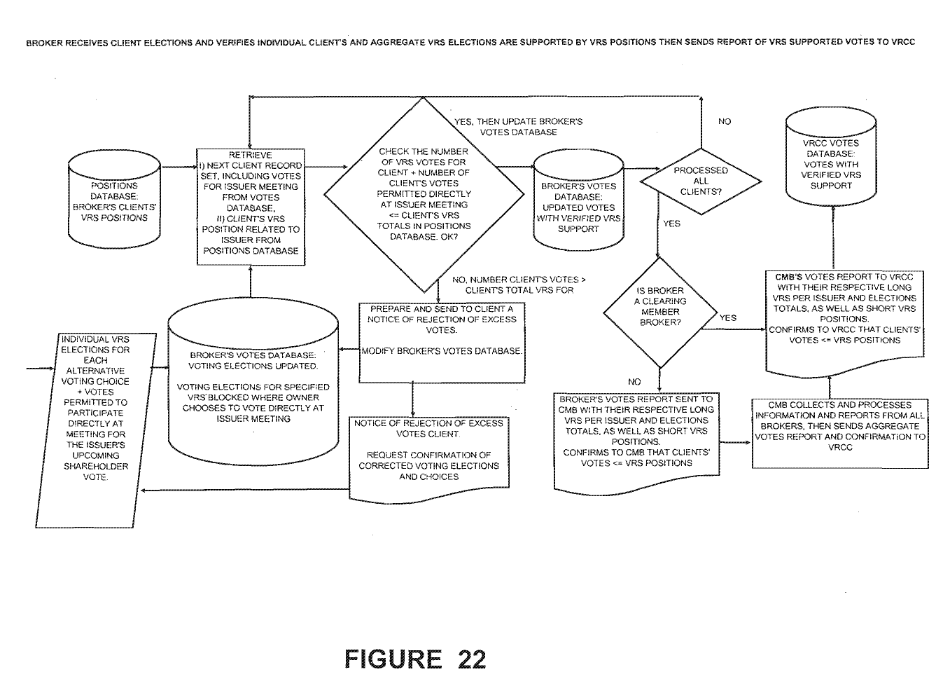

FIG. 23 shows VRCC checks for each CMB that total VRS votes per Equity Issuer<=total VRS per Issuer; rejects CMB's total or individual excess VRS votes;

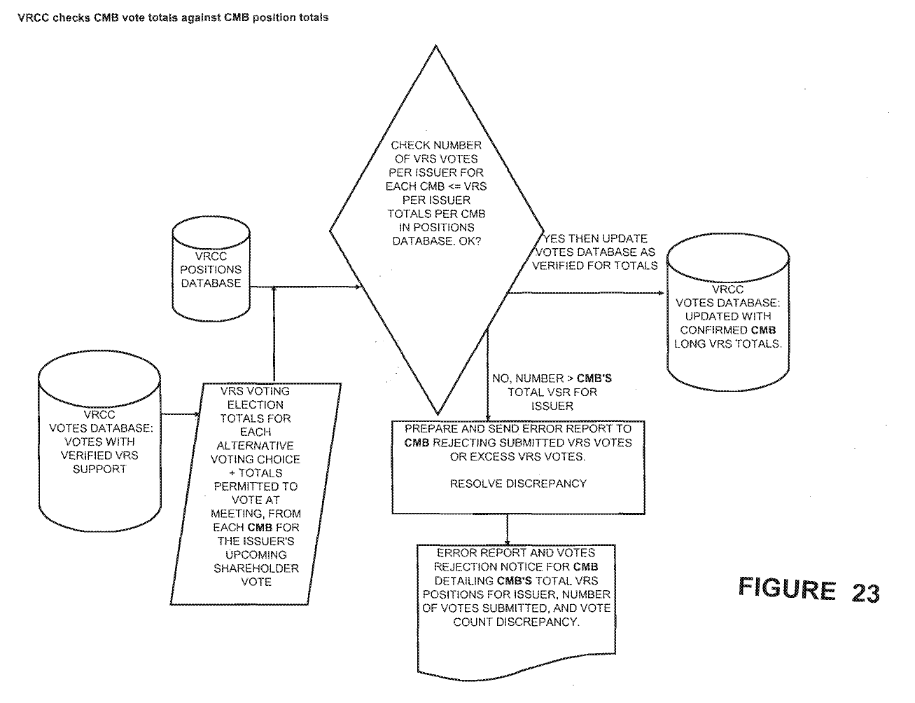

FIG. 24 shows each CMB checks that VRS vote totals per Equity Issuer<=total VRS per Issuer; rejects individual excess VRS votes;

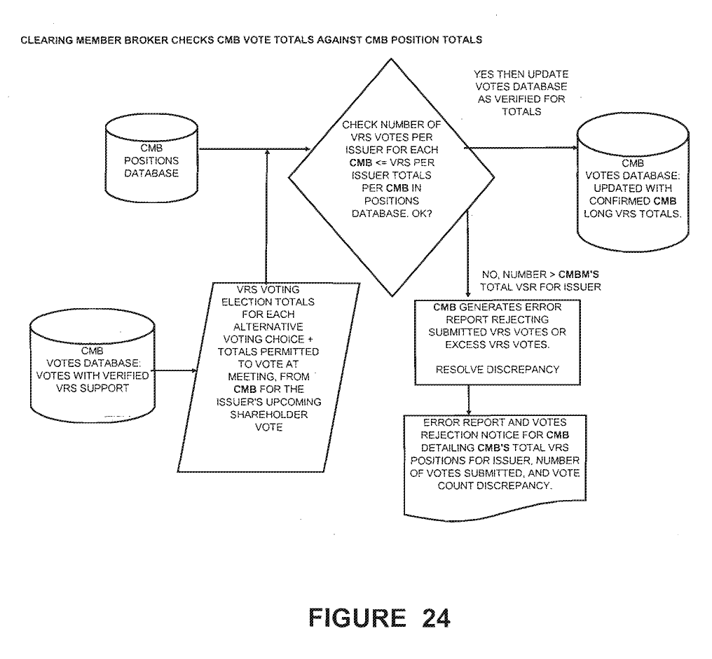

FIG. 25 determines whether Elect3A or Elect3B process should be used;

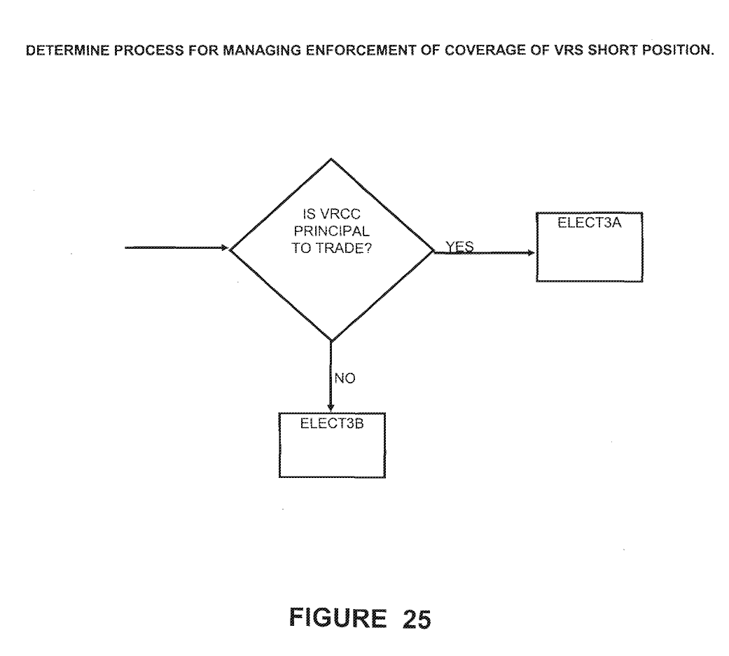

FIG. 26 shows where VRCC is principal to every VRS transaction, it checks for each CMB total VRS votes per Equity Issuer<=total VRS per Issuer, rejects CMB's total or individual excess VRS votes;

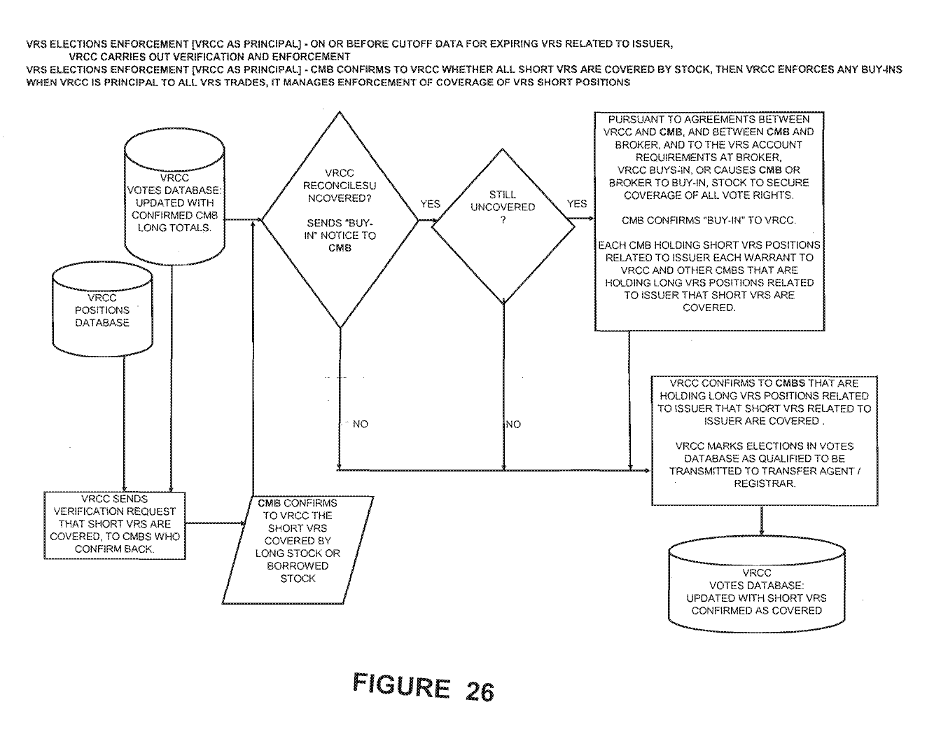

FIG. 27 shows where VRCC is guarantor to every VRS transaction, each CMB checks for correct VRS vote totals, rejects CMB's total or individual excess VRS votes;

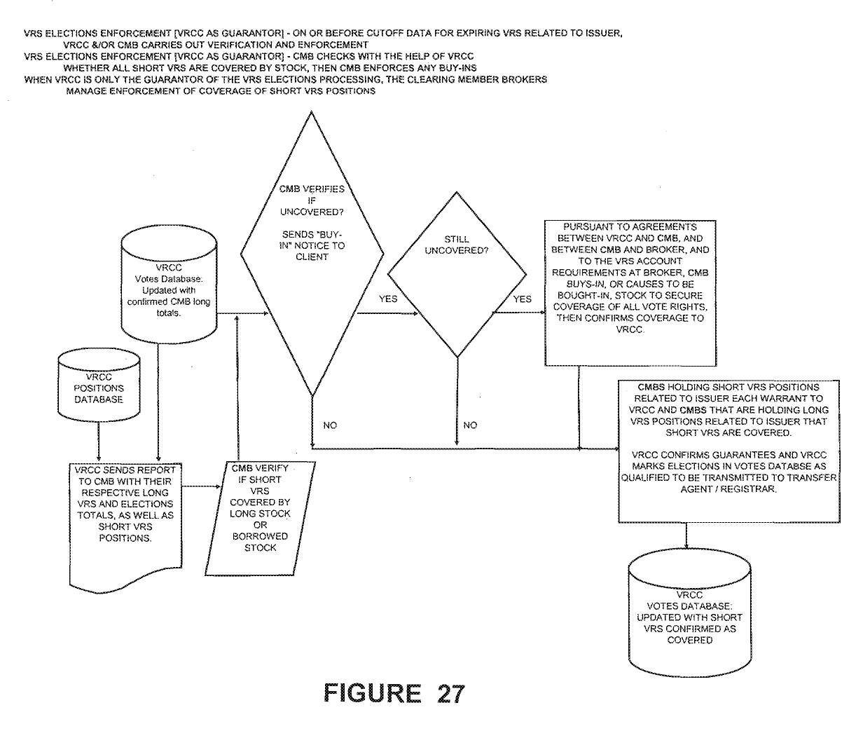

FIG. 28 shows generating and transmitting to Transfer Agent/Registrar the voting reports for each VRS and confirmation that short VRS are covered;

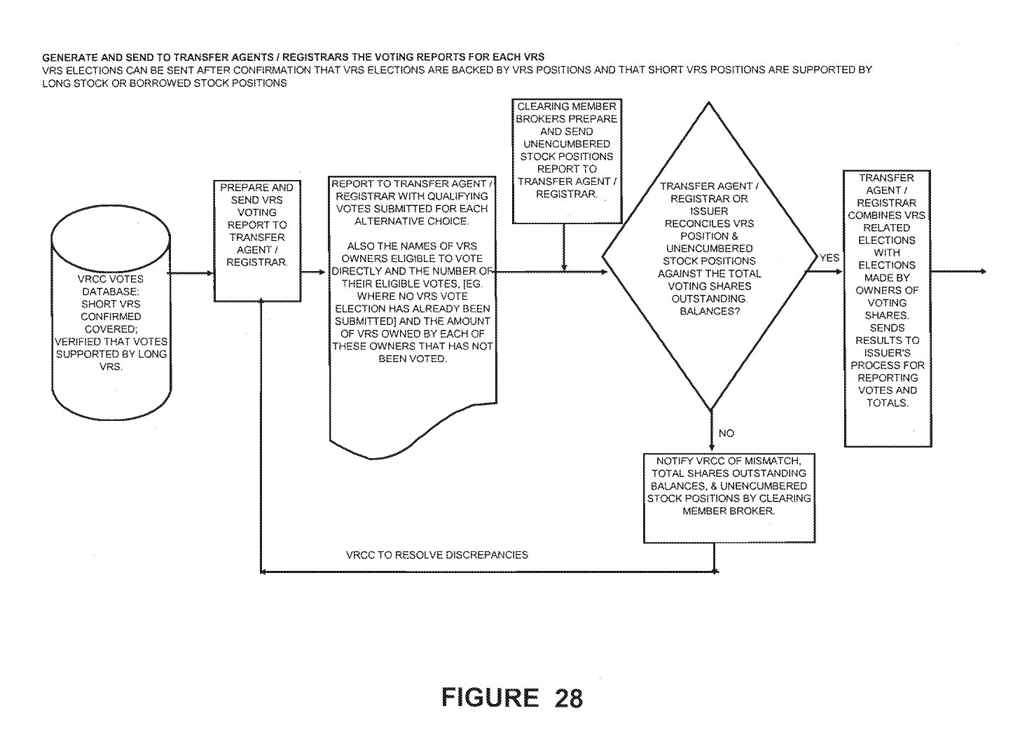

FIG. 29 shows VRCC reconciles VRS elections and direct election requests against total VRS positions; transmits acceptable VRS elections & direct election requests to Transfer Agent/Registrar;

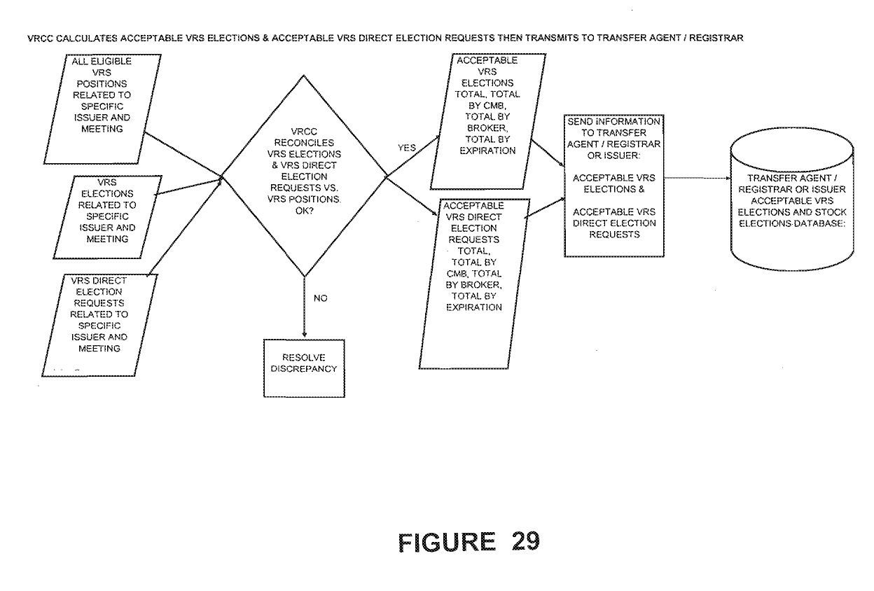

FIG. 30 shows Transfer Agent/Registrar reconciles data to determine eligible positions then registers acceptable elections;

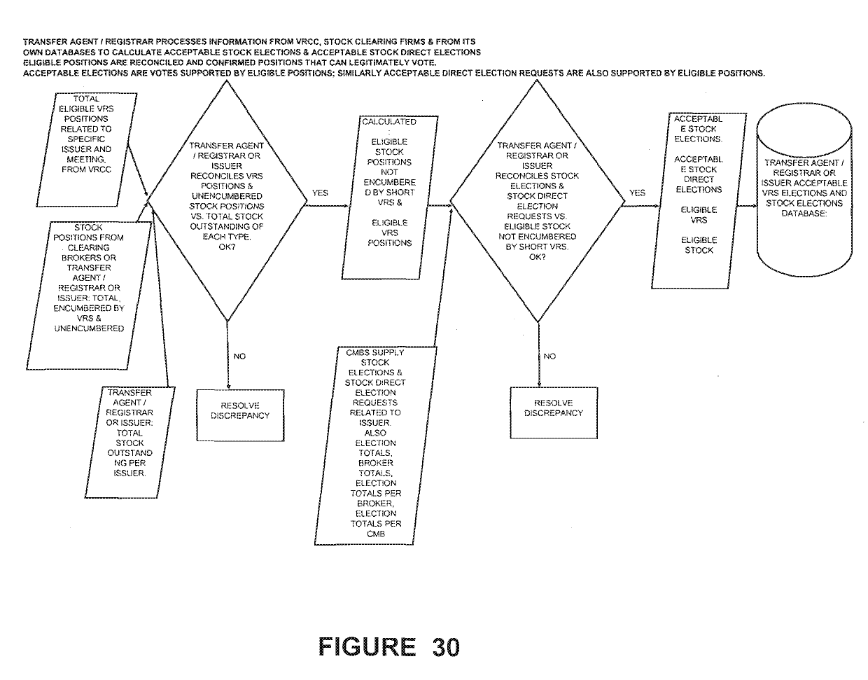

FIG. 31 shows Transfer Agent/Registrar reconciles all acceptable elections and all direct election requests to give permitted elections. Calculates Total Permitted Elections;

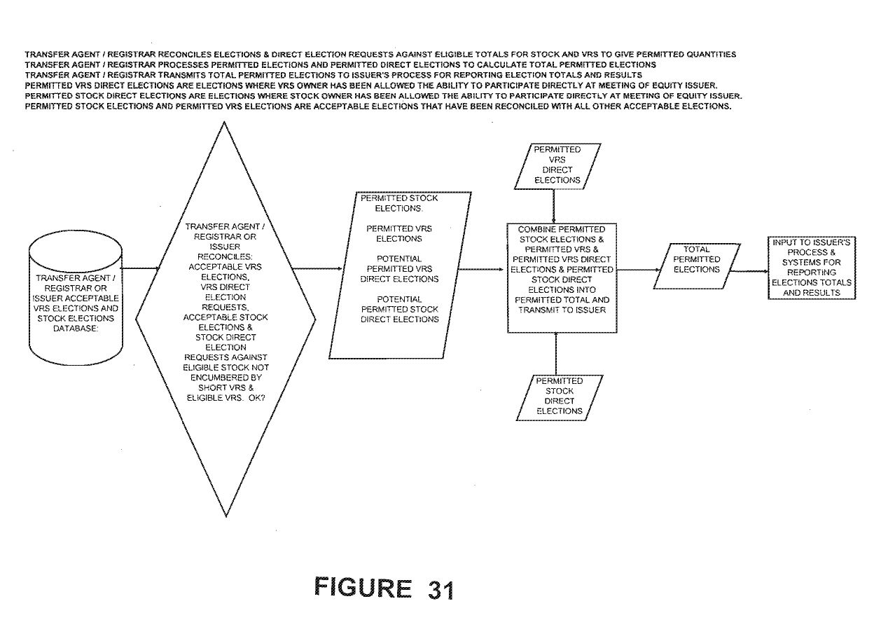

FIG. 32 is another aspect of the present invention;

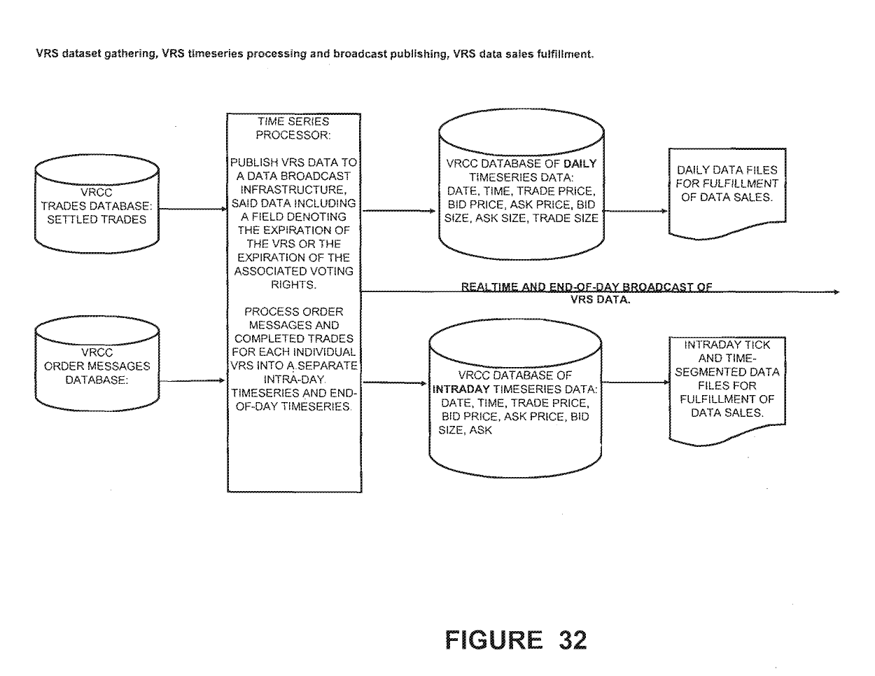

FIG. 33 is another aspect of the present invention;

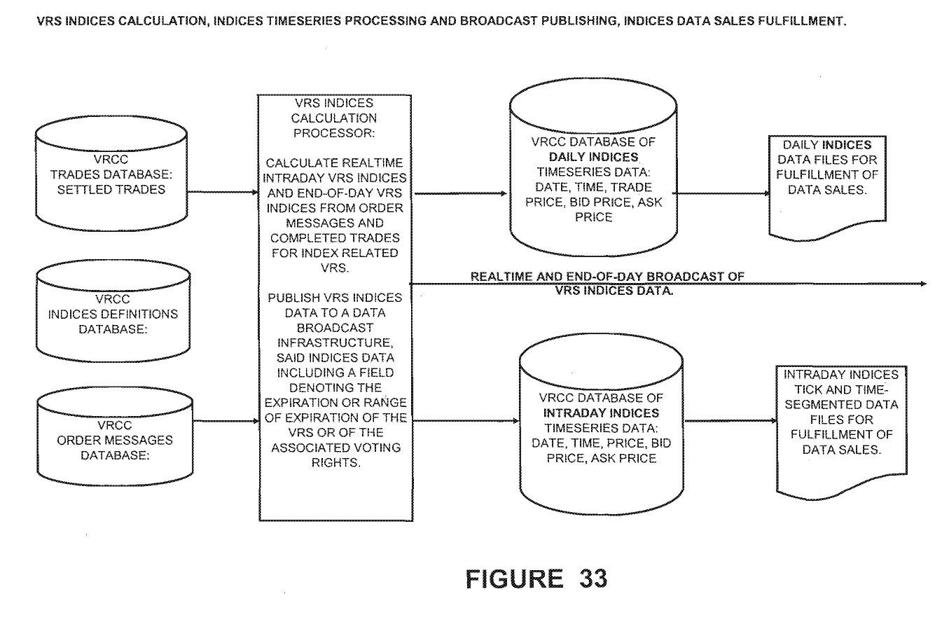

FIG. 34 shows one embodiment of a VRS trading system; and

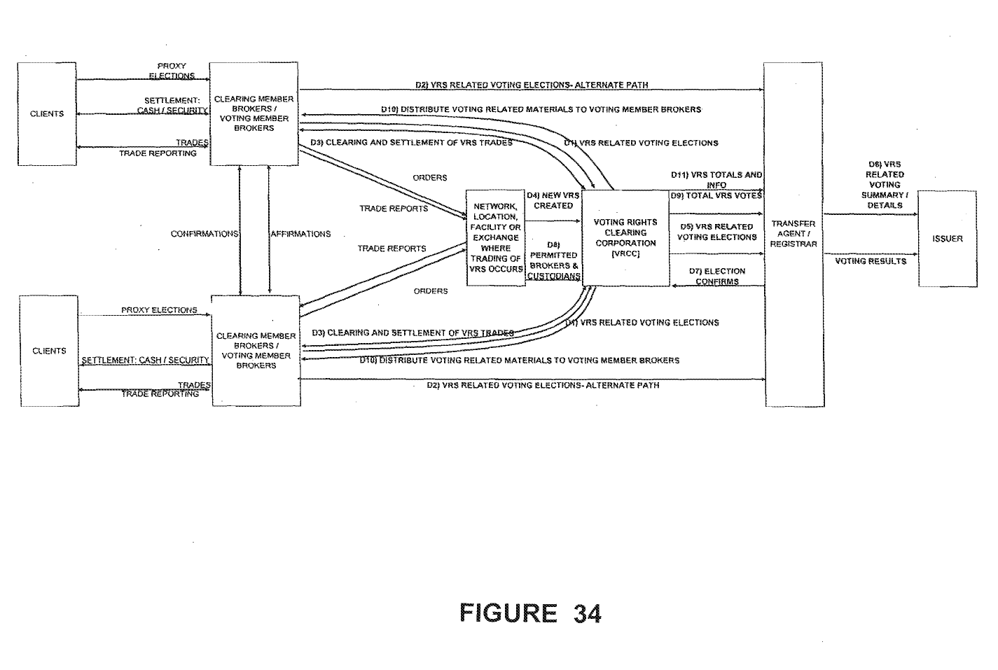

FIG. 35 shows a second embodiment of a VRS trading system.

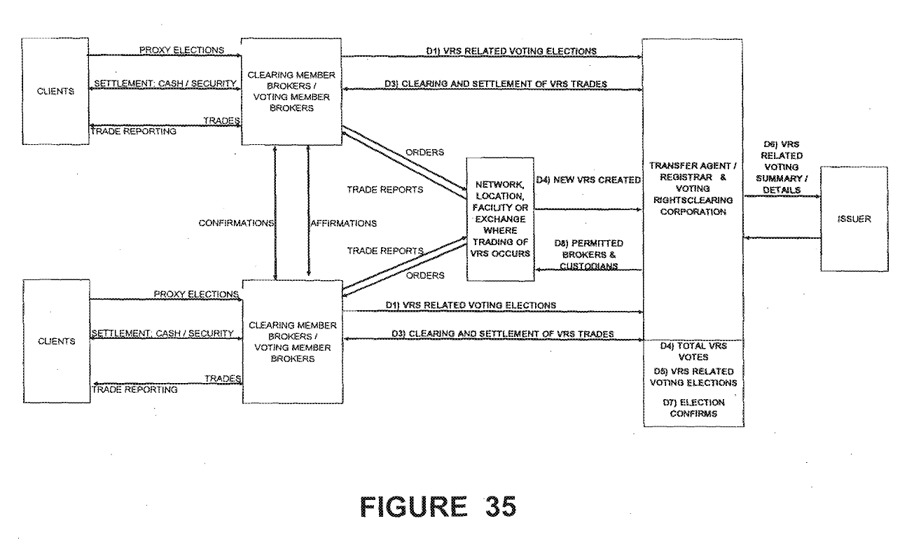

### DETAILED DESCRIPTION OF THE PREFERRED EMBODIMENTS

In this description the following terms shall have the following meanings:
VRS shall mean a voting right security in which the voting right is substantially separated from any of the other underlying rights and benefits that accrue by means of share ownership which permits the VRS to be priced to or an open exchange to determine a value for the voting right associated with said VRS. There are several different configurations for a voting right security as outlined below.

VRCC shall mean the voting right clearing corporation where trades between brokers of the VRS are cleared at the end of a trading period.

A broker that is permitted to clear and settle VRS trades with the VRCC are Clearing Member Broker (“CMB”).

Any network, location, market, exchange or process wherein buyers and sellers can be brought together, physically or electronically, in order to agree to or complete transactions of purchase or sale of VRS is an exchange (“Exchange”).

VRCC Trade Message Process shall mean the process to track and record all VRS trades which are made between the CMBs on the Exchange, where the VRS trades are executed, and the VRCC This is described in more detail below.

The fundamental characteristics of a VRS are a) separation of the rights, or control over the rights, to participate in shareholder meetings and make elections on issues pertaining to direction of the Equity Issuer company from the source bundle of rights, b) ability to exercise those rights to participate in shareholder meetings and make elections on issues pertaining to direction of the Equity Issuer company, c) fungibility such that the VRS can be freely traded between parties without also trading the residual of the source bundle of rights so as to establish a value for the VRS on an open market. To achieve this separation there are several basic alternatives:
i) non-transferable contracts which pass the voting rights embedded in equity securities from the owner of the shares to the holder of the contract;
ii) non-transferable contracts which control the voting activity related to the voting rights embedded in equity securities;
iii) transferable contracts which pass the voting rights embedded in equity securities from the owner of the shares to the holder of the contract [herein called Voting Rights Contracts];
iv) transferable contracts which control the voting activity related to the voting rights embedded in equity securities [herein called Controlled Voting Contracts];

The transferable versions are preferred. Voting Rights Contracts and Controlled Voting Contracts are transferable but there may be challenges to integrating these into existing trading infrastructure. As a result it may potentially be advantageous to shift the control of the voting right into an intermediary entity that facilitates the transferability of the VRS. These form the basis of the next VRS forms:
v) shares [herein called Voting Rights Special Purpose Shares] of a special purpose corporation that holds or controls such voting rights via one of the basic shifting alternatives;
vi) units [herein called Voting Rights Special Purpose Units] of a trust or partnership that holds or controls such voting rights via one of the basic shifting alternatives;

In the previous examples the shareholder gave up control over, or contracted away part of, his rights. Another possibility is that the Equity Issuer creates a special class of unit or share that is not an equity since it lacks rights in liquidation and dividend rights, but has voting rights.
vii) a special class of shares [herein called Voting Rights Special Shares] of the underlying source equity corporation that do not possess rights to the dividends of the corporation and do not possess rights in liquidation of the corporation.

Use of standardised forms of securities or derivatives are desirable to help the development of a public market for, and attract greater participation in, these products. The creation of the VRS can be standardised in two ways. The first means is to set standardised expiration dates, as well as terms and conditions, in the case of Voting Rights Contracts and Controlled Voting Contracts. Examples of these expiration mechanisms are fixed quarterly expiration dates; expiration a set number of days after or immediately after the Equity Issuer's quarterly results; expiration a set number of days after or immediately after the Equity Issuer's annual meeting. The expiration mechanism may apply to the ability to exercise the voting right or exercise control over the voting right. Alternately it may be applied to the existence of the VRS itself which is the preferred embodiment.

The second standardization means is through the issuance of VRS via a prospectus based public offering which would be required in the case of Voting Rights Special Purpose Shares, Voting Rights Special Purpose Units or Voting Rights Special Shares. All of these prospectus based transferable securities are herein known as Source VRS.

In a preferred embodiment of VRS, called, Controlled Voting Contracts, owners of shares of an Equity Issuer can create new VRS by executing an initiating sale transaction on an Exchange with a buyer of the same VRS. The actual transactions that would occur within the preferred embodiment of supporting systems involve each VRS sale on the Exchange having the VRCC as the counterparty buyer, while each VRS purchase on the Exchange involves VRCC as the counterparty seller. According to the present invention the VRCC can be located in the middle of each Exchange transaction as the counterparty to each side of an Exchange transaction.

An initiating seller may close out its obligations by buying an identical VRS on the same Equity Issuer with the same expiration date and any other relevant features matching. Similarly a VRS buyer can close out its VRS position by carrying out a long sale of an identical VRS on the same Equity Issuer with the same expiration date and any other relevant features matching. When an initiating VRS sale occurs it encumbers the shares of the Equity Issuer held by the seller.

The VRS buyer relies on these encumbered shares to be able to make elections relating to the Equity Issuer. The VRCC Trade Message Process permits the VRCC to track which Clearing Member Brokers participated in each transaction, and at the same time permits each CMB to track which Approved Client or which Broker participated in each transaction. Every Broker that has Approved Clients that want to trade VRS, every CMB that itself has Approved Clients that want to trade VRS or clears VRS for other Brokers, as well as Holding Brokers or other Financial Firms that participate in VRS transactions (“Participants”) must implement procedures that govern accounts that hold VRS and that hold stock encumbered by the issuance of VRS. In particular where an Approved Client account that has created VRS through an initiating sale the Participant must either have the underlying shares (now encumbered) or it must borrow the underlying shares, or it must have a mechanism such as equity capital requirements in the account to ensure there are sufficient funds to purchase the underlying shares. Furthermore said Participants must agree that, on or a set number of days before the date that the Transfer Agent/Registrar or the Equity Issuer sets for determining to ownership of shares and their associated voting rights, they will ensure the relevant Approved Client's account owns and possesses sufficient shares to cover any VRS created by that Approved Client.

Derivatives contracts such as options, futures, contract-for-differences and swaps can be based on this invention of VRS [herein known as VRS Derivative]. These VRS Derivatives can be exchange traded or traded over-the-counter [“OTC”] between creditworthy counterparties. The primary rationale and advantage of exchange traded securities or derivatives is standardization which permits rapid transactions and easier evaluation, whereas OTC transactions provide greater flexibility through customization but require more time to create and assess.

The derivatives can be created on the non-transferable forms i) or ii), or include the language of the non-transferable form within its contract such as a total return swap that includes the transfer or control over the voting rights. The derivatives may also be created on any of the Source VRS. The payoff can be control or possession of the voting right; or predicated on some formula dealing with the price or value of VRS. Finally, options may be created on VRS futures or VRS swaps.

Several specific, unique forms of Derivative VRS are worth listing:
VRS Event Controlled Security. An alternative embodiment of this invention is a sub-class of investment security that provides voting rights conditional upon an event, or some combination of events, occurring within a pre-specified time period. Once the conditional trigger is satisfied then the right to vote shall be activated either immediately or after any other timing or scheduling variation that a practitioner skilled in the art might contemplate. The difference between this and a Derivative VRS option is that in the case of a Derivative VRS option the conditioning event or events are based on the price of the underlying VRS while for a VRS Event Controlled Security the conditioning could relate to any type of non-VRS related event.

An alternative embodiment of this invention is a sub-class of investment security that immediately provides voting rights but conditional upon an event, or some combination of events, not occurring within a pre-specified time period, eg. stock price not declining below $40, or average temperature not exceeding 24 C during June. Once the conditional trigger is satisfied then the right to vote shall be terminated, either immediately or after any other timing or scheduling variation that a practioner skilled in the art might contemplate.

In each case conditions may require a single occurrence or multiple occurrences to trigger [a digital trigger], or may remain triggered only for the period that triggers are satisfied, eg. a continuous digital trigger, in a similar manner to a regular call option wherein the right to appreciation only applies when price is above a strike price.
ii) VRS Principal protected notes. An alternate embodiment of this invention is a sub-class of voting rights securities whereby an issuer of certificates of deposit or guaranteed investment certificates, or an issuer of debentures or notes, acquires voting rights or voting rights securities. The interest of an issuance of notes or of an issuance of certificates of deposits may be predicated in whole or in part on the value of, or the change in value of, those acquired rights or VRS. Alternatively the payoff to the VRS principal protected note may include the ability to exercise these acquired rights or VRS, or to take delivery of said acquired rights or VRS.
iii) VRS Indices and Derivatives on VRS Indices. Another concept comprehended by the present invention which is analogous to current practices in the derivatives market is that of indexation, in which the value of a derivative is predicated on, or tracks, the value of an underlying index instead of an underlying security. Often the advantage of such a derivative is to avoid legal, regulatory, tax or financial requirements related to transactions in the underlying security. Therefore the present invention further comprehends deriving from the VRS class an index based on a group of voting rights securities (“Index VRS”). Examples include an index comprised of the equal weighted values of the voting rights securities of the 25 worst performing stocks within the S&P 500 index group of stocks, or an index comprised the capitalization weighted values of the voting rights securities of the 50 fastest growing stocks with a market capitalization greater than $500 million. While various measures are comprehended for identifying the underlying issuer, the common element of the index according to the present invention is the inclusion of a quantity based on a measure of value of one or more VRS values established by an open market or exchange.

Thus, an Index VRS can be limited to an individual VRS. Two additional sub-classes of VRS are (“Public Index VRS Derivative”) and (“OTC Index VRS Derivative”). Furthermore options on a VRS index are a type of VRS Option, while options on a futures contract based on a VRS index and options on an OTC swap based on a VRS index are types of VRS Derivatives Options.
iv) VRS Wager. A bet related to VRS [herein called Digital VRS Contract] has a digital condition that when triggered provides a fixed financial payoff and/or the ability to exercise these acquired rights or VRS, or to take delivery of said acquired rights or VRS. The Digital VRS Contract mixes trigger condition features and payoff features of a VRS Derivative Option and a VRS Event Controlled Security. However the Digital VRS Contract terms must relate to VRS in at least one or more of the following ways: the trigger condition relates to VRS prices; the payoff relates to VRS prices; the payoff transfers the VRS related voting rights.

Means used by Intermediary Entity. Another derivative security that has previously been created is a security that receives some portion or all of the dividends associated with an underlying stock, leaving the stockholder with the net rights to capital appreciation/depreciation, liquidation rights and voting rights. Sometimes these derivative securities provide the buyer not only rights to the dividends but also some call-type or put-type participation in the appreciation or depreciation of the underlying stock. Often a trust or a corporation or an OTC swap counterparty is used as the intermediary entity that holds the equity and acts as the pass-through of different components of return.

In the case of the trust, or the corporation, or a counterparty to an over the counter transaction, any of which are used as an intermediary vehicle that then issues its own securities, the rights may be acquired by the intermediary vehicle by means of futures contract, option contract, OTC swap, CFD or execution of either a transferable or a non-transferable contract to acquire such voting rights. Furthermore, the acquisition of such voting rights may be the outcome of a bet type transaction. In other words, whether the voting rights security is created by the shareholder of the underlying corporation, or by the corporation itself, or by a derivatives counterparty, the transfer of voting rights required to enable the voting rights securities may be carried out using shares or by using an existing VRS or a derivative thereon or another means that a practitioner skilled in the art would reasonably contemplate.

All of these embodiments are comprehended within a general group of “voting rights securities” or VRS according to the present invention. A preferred form of the invention is a Controlled Voting Contracts variation of VRS and the residual security VCS, but the present invention comprehends these and other variations of VRS in which the voting rights of a corporation, are separated from other rights to equity or share ownership, to permit the voting rights to be traded to establish a value associated with the tradable voting rights. While these voting rights may be completely separated, in one embodiment, the present invention contemplates other embodiments where the voting rights are associated with one or more of other ownership rights, which are tradable, separate and apart from the remaining residual rights and can be determined by buyers and sellers. According to the present invention there is also provided a means for carrying out transactions for clearance and settlement of the VRS securities as described in more detail below.

According to the present invention the general class of VRS is divided into sub-classes based on the mechanisms for creation of the VRS and the means of clearance/settlement. The primary sub-classes are:
i. Exchange traded VRS created by means of an underwriting of VRS trust units, or of VRS shares of a special purpose corporation, or of VRS special shares issued by the underlying source corporation.
ii. Private transactions in VRS subject to securities regulation and created by means of a private placement of VRS trust units, or of VRS shares of a special purpose corporation, or of VRS special shares issued by the underlying source corporation.
iii. Exchange traded derivatives on VRS created by the seller of a derivative through the actions of a clearing corporation that guarantees the fulfillment of contract terms.
iv. Over the counter derivatives on VRS in which payments related to the transaction and in which fulfillment of contract terms are guaranteed at least in part by one or other of the parties, or by both parties, to the transaction. Alternatively OTC derivatives on VRS which are subject to ISDA definitions.

### VRCC Processes

The attached drawings illustrate certain aspects of the processes of the present invention for the clearance and settling of trades or transactions in the VRS according to a preferred aspect of the present invention are described. The preferred process includes the following steps:

In this process the Clearing Member Broker (“CMB”) for the selling trade sends a trade confirmation to the CMB on the buy side of the trade executed on the Exchange. Once the confirm is compared against trade messages received from the Exchange and agreed to, the CMB recipient of the confirmation sends an affirmation back.

VRS have to be identified by the features which can differentiate between each individual VRS on the same class of security of the Equity Issuer. Such features include expiration date, the term to expiration, the number of votes per VRS, the provider of the voting rights (generally the owner of the underlying shares), the price paid for the VRS, and where relevant any trigger conditions that enable or disable the voting rights, any deferral of the commencement of the VRS voting rights or deferral of any trigger conditions that enable or disable the VRS voting rights.

One aspect of the present invention is this unique, differentiating descriptive set of enabling features which may be captured amongst multiple data fields or encapsulated in a single symbology type code. When a symbology is used the systems will need to decode the critical features so that functions that rely on these features may operate. Examples are the voting right expiration date of the vote election cut-off date, both of which will need to be processed as dates or days to expiration rather than a alpha-numeric code. Another aspect of the present invention is the method of translating such a symbology into the VRS enabling feature descriptors.

Existing systems for trading, processing, clearing and settlement of equity securities and equity options do not accommodate these enabling features nor an information set that adequately describes transactions in the VRS. These features are important for the present invention to be able to determine when and how to exercise any voting rights embedded in the VRS.

The conventional financial services industry is fragmented amongst many participants carrying out specialized niche functions/processes within the value chain. Some Financial Firms carry out all these internally, but many outsource processes in which they have no competitive advantage. Similar situations may occur according to the present invention. Therefore note that the Executing Broker may or may not be the same as the Clearing Broker. The Executing Broker may execute trades for other brokers on an Exchange so the Executing Broker that executes the trade may be different from the Originating Broker that originated the trade through the Executing Broker. If the Executing Broker is different from the CMB, the Executing Broker delivers the executed trade to the CMB as specified in the Originating Broker's order or as specified in their contractual relationship. Further, the Originating Brokers may differ from brokers/custodians holding VRS for clients (“Holding Broker”) since the Originating Broker may deliver the VRS position to [from] the Holding Broker against a cash payment from [to] the Holding Broker for long [short] positions. In this description Approved Clients of Clearing Member Brokers trade VRS through an Exchange supported by the VRCC. However the processes include more complex sub-divisions of the process value chain between these different types of broker as would be reasonably contemplated by a practioner skilled in the art.

VRCC receives from the CMBs or the Exchange the trade messages related to each transaction which include a tag to identify covered sells, covering buys, long sells and buys, a tag identifying the broker executing (“Executing Broker”), the trade details, such as underlying equity, quantity and price, information that identifies the expiration date directly or by reference, and may include the CMB that is supposed to clear and settle the trade. Other message fields that may also be needed include: i) the name of the client of the Executing Broker, ii) the name of the Financial Firm (“Originating Broker”) whose client account originated the VRS trade, iii) the identifier of the broker/custodian that holds the VRS position for the owner client (“Holding Broker”) and iv) the client account type, where the client account type may be client, proprietary, market-maker, specialist, etc.

During the day, or at the end of the day or at the end of the trading period which may be of any convenient length, the CMBs send lists of confirmed/affirmed trades to the VRCC for clearing.

At the end of the trading period the VRCC nets the amounts of each CMB to a single balance to be paid to VRCC if the CMB has bought more that it has sold, or to be paid by VRCC if the CMB has sold more that it has bought.

VRCC aggregates the VRS created per CMB and the VRS created per CMB by account type;
VRCC transmits VRS aggregate positions per CMB as well as aggregate VRS originated per CMB to Transfer Agent/Registrar;
VRCC receives from Transfer Agent/Registrar VRS voting related information/instructions/forms;
VRCC transmits VRS related voting information/instructions/forms to CMB;
VRCC receives the VRS voting rights elections from CMB [eg. not Holding Brokers unless one in the same], then may request the CMB confirm the holdings of the Holding Brokers.
Where a Holding Broker has insufficient coverage of the created VRS with stock of the Equity Issuer, VRCC either sends a buy-in notice forcing the CMB to buy shares for the customer, or requiring the CMB to force the Holding Broker to buy the shares, or the VRCC buys the shares to cover the shortfall and charges the CMB.
VRCC transmits the VRS voting rights elections to Transfer Agent/Registrar
VRCC may transmit to the Exchange an updated list of CMB approved to transact in VRS.

### VRS Index Calculation

VRCC may calculate a any of a variety of weighted VRS indices. For instance an index may be cap weighted or equal weighted VRS index based on either a number of the highest average value VRS over a prior period, or a number of the highest value VRS at certain dates [such as quarterly rebalance dates], or a number of the most actively traded VRS during a prior period, or a number of the most actively traded VRS at certain dates [such as quarterly rebalance dates], or a number of the VRS which have the highest portion of outstanding VRS relative to outstanding shares [relatively highest originated], or a number of the VRS which have the highest number of outstanding VRS.

### Transfer Agent/Registrar

Transfer Agent/Registrar receives VRS aggregate per Holding Broker, aggregate VRS originated per Originating Brokerand aggregate VRS originated per CMB from VRCCas needed. Separately the Transfer Agent/Registrar receives non-VRS-encumbered share aggregates per Equity Issuer as well as VRS-encumbered share aggregates per Equity Issuer from the brokers, and it compares these totals to the total outstanding shares per equity for each Equity Issuer.

Transfer Agent/Registrar sends to VRCC any VRS related voting information/instructions/forms.

Transfer Agent/Registrar receives VRS related voting rights elections from VRCC, it aggregates these with standard share votes and submits the results to the Equity Issuer.

### VRS Brokerage Processes

The processes and methods related to said VRS securities and affected equity securities according to the present invention include:
tracking of and accounting for customer positions;
tracking of and accounting for customer income, expenses, gains and losses;
change of ownership; communicating and processing customer votes in VRS;
communicating to and processing customer voting elections with Equity Issuers and their Transfer Agent/Registrars via the VRCC, in stocks for which some part of the voting rights have been traded to another party aside from the owner of the equity securities by using VRS;
stock lending of VRS and of stocks for which some part of the voting rights have been traded to another party.

In addition to the creation of the VRS as well as the settling and confirmation of the transactions, the present invention comprehends processes and systems for properly according the owner of the VRS the right to exercise the vote in accordance with the VRS voting rights. The voting process is now described according to a preferred embodiment of the present invention.

### Contrast to Existing Industry Systems and Processes

Since the classes of VRS contemplated herein are all created between clients of Financial Firms, when the owner of a VRS wishes to vote, the transfer agent/registrar, or VRCC a new third party organization created for this purpose, needs to be informed of the VRS owners' identities and the terms and conditions under which the voting rights are held. The internal systems, or the third party systems, used by Financial Firms for tracking client holdings and communicating with transfer agents/registrars or the equity security issuers do not accommodate these required capabilities. Nor can their systems remove from total voting rights calculations the voting rights associated with clients' holdings of equity securities that have been used or encumbered to create VRS.

Both the internal systems and the third party systems used by Transfer Agent/Registrars to receive voting information about clients' voting rights or about voting rights of clients of Financial Firms, do not have the capability of receiving or processing this VRS related information. Furthermore, neither the systems of Transfer Agent/Registrars nor third party data processing systems that support the securities transaction processing industry have the capability of processing or forwarding this VRS related information for the purpose of summarizing which individuals and Financial Firms are the holders of VRS and their associated voting rights, and the relevant quantities thereof that relate to any specific Equity Issuer. The Transfer Agent/Registrar's own internal systems and the third party data processing systems are not able to calculate, process, or communicate the results of, the vote elections made by owners of VRS.

Once an owner of an equity security creates a VRS and sells or transfers the rights associated with that VRS to another party, the remaining holding of the equity security is impacted. The equity security held by that original owner now possesses a share in a corporation less the voting rights that have been utilized to create the VRS. In other words it is no longer simply the original undiminished bundle of rights issued by the underlying corporation. Many of the process methods of Financial Firms that relate to managing, administrating, accounting for, assessing and processing the holdings of their clients are impacted by the creation by these clients of VRS, or of derivatives on VRS.

The current systems and methods of Financial Firms are not able to distinguishing between equity securities and equity securities encumbered through the creation of VRS. Nor are they able to track, account for or transfer either the equity securities encumbered through the creation of VRS, or the VRS themselves, or derivatives on VRS. They are unable to alter the financing conditions associated with the margin lending to clients for their holdings of equity securities encumbered through the creation of VRS. Nor are they able to process the lending of these securities as these will have to be handled differently from the unaltered equity security.

Financial Firms can set the margin capital that each customer is required to keep in its account based on the risk of the positions in that customer's accounts. The Financial Firms themselves must post capital based on the potential risks of their customers' positions and their own positions. The current systems and process methods cannot include either the equity securities encumbered through the creation of VRS, or the VRS themselves, or derivatives on VRS.

Financial Firms and the order routing systems that they use to send orders to liquidity destinations, such as exchanges, electronic communications networks (“ECNs”), dealers' principal trading desks, or securities trade matching services, do not handle orders in either equity securities encumbered through the creation of VRS, or the VRS themselves, or derivatives on VRS. Moreover, no Exchanges trade VRS, nor can they handle trades in VRS, or in derivatives on VRS without significantly modifying the information they currently use to complete a trade. Finally, the systems that transmit price and volume data on bid/ask quotes as well as completed trades in publicly listed securities do not handle the information set required to report trading in publicly listed VRS, or derivatives on VRS.

According to the present invention there are many new system requirements that are needed to support the VRS exchange and the settlement and clearance of the VRS transactions. Some of the preferred systems and process requirements are articulated below:

In respect of the VRS:
i) publish various standardized documents which upon signing by the appropriate party(ies) creates the issue of the desired sub-class of VRS, including the rights and obligations of the buyer and/or of the seller, as well as the processes and procedures for voting said VRS, or taking direct possession of said voting rights;
ii) publish various standardized documents that are referenced and invoked when a trade any of certain sub-class(es) of VRS is initiated;
iii) publish account opening or account regulating documents governing transactions in the selected sub-classes of VRS;

In respect of the VRS Enabling systems and processes
iv) reporting of aggregate and net holdings in voting rights securities by clients and their representative brokerage firms to the issuers or to the issuer's transfer agent or to the issuer's depository;
v) the distribution of materials to the holders of voting rights, relating to issues that the issuing corporations are putting to vote by those possessing voting rights
vi) exercise of voting rights by transmission of required documentation, to the issuing corporations and/or their agents relating to the choices made by owners of voting rights;

In respect of the VRS Trading systems
vii) support the trading of this new class of securities on an exchange or on an electronic communications network (commonly know as “ECN”) or on a private matching facility such as Pipeline, Instinet Match or BIDS;
viii) support the OTC swap transacting of this new class of securities;

In respect of the VRS Data acquisition and distribution
ix) capturing, saving, repackaging, broadcasting or reselling trade data, including price data, volume data, timestamp data and/or information relating to VRS and its structure;
x) creating indices in whole or in part based upon the value of the value of voting rights securities;

In respect of the VRS Transaction Enabling Systems and Processes
xi) enable the clearing, settlement, position tracking and brokerage reporting to clients;
xii) calculate appropriate margin requirements for margin positions of voting rights securities, calculate margin excess or deficiency, issue margin calls related to margin deficiency in such securities;
xiii) verify covered positions, mark client accounts as uncovered acceptable or “only covered”, flag uncovered positions, flag “only covered” violations, notify clients of violations, notify non “auto-borrow” clients of need to correct;
xiv) manage borrow of stock or of voting rights securities to satisfy uncovered positions, force liquidate excess or overdue uncovered positions, track covering borrows, their costs and charge borrow costs;
xv) match trades, flag mismatched trades, calculate net settlement obligations and maintain inventories;

In respect of the VRS Transactions Guaranteeing Systems
xvi) guarantee the payments involved in, and the fulfillment of terms of, transactions in voting rights securities;
xvii) guarantee the payments involved in, and the fulfillment of terms of, derivatives transactions based on voting rights securities;
xviii) enable the provision of trust services or custody services for holding or safekeeping of voting rights securities, or for exchange traded derivatives thereon;

While the foregoing description includes various preferred embodiments of the present invention, it will be appreciated by those skilled in the art that the true scope of the invention is defined by the attached claims. Various variations and alternate embodiments are comprehended by the present invention, which do not depart from the scope of such claims, such as the various forms of voting right security that have been described either directly or indirectly above. These and other variations will be understood by those skilled in the art to fall within the ambit of the present invention.

I claim:

1. A method of clearing and settling a voting right security trade traded by brokers on an exchange, the method comprising:
Separating a voting right arising in relation to a financial security from the ownership of the underlying financial security to create a tradable voting right security (VRS),
Registering the particulars of the VRS with a Transfer agent/Registrar and a VRS clearing corporation,
Trading said VRS on said exchange,
Communicating certain particulars of said broker trades of said VRS to a VRS clearing corporation at the end of each trading period,
Computing the sum of the trades of each broker at the VRS clearing corporation to determine any outstanding balances owing at the end of the trading period,
Communicating the sum of the transactions at the end of the trading period from the VRS clearing corporation to the Transfer agent/Registrar, and
Settling the outstanding balances between the VRS clearing corporation and the brokers.

2. A data processing system for administering a tradable voting right security which comprises only the right to vote in an issuer's shareholder vote, the system comprising:
Computer means for recording the particulars of the voting right security,
Data entry means for entering sufficient particulars of any trades of the voting right security in a trading period to permit a computation of both the net and the sum of all trades made by traders in said voting right securities at the end of the trading period;
Data computational means to permit said trading of said voting right securities to be netted and summed at the end of each trading period to determine any outstanding balances receivable or payable owed at the end of the trading period relative to said trades; and
Communication means to communicate the outstanding balances to the traders and the resultant positions in said voting right securities to a transfer agent/registrar.

3. The data processing system as claimed in claim 2 further including a means for owners of VRS to express their voting intentions, and for the VRS clearing corporation to transmit individual voting intentions, aggregate votes and aggregates by type of election available, and summary voting statistics to a transfer agent/registrar.

4. The data processing system as claimed in claim 2 further including a means for calculating and tracking one or more of the following, a total number of VRS outstanding per issuer, a number of VRS per owner that have already voted, a number of VRS that have requested to vote directly at corporate events and a number of VRS with votes still pending.

5. The data processing system as claimed in claim 2 further including a means by which VRS owners can request to vote directly at corporate event of an equity issuer, by which VRS clearing corporation instructs a transfer agent/registrar about the VRS owners planning to vote directly at the issuer's corporate meeting event, and by which the VRS clearing corporation provides any of said VRS owners with sufficient information to enable the VRS owner to participate at the corporate meeting event, by voting some or all of the votes controlled by said VRS owner through its ownership of said VRS.

6. A tradable security comprising:
a voting right arising from an underlying financial security having both voting rights and residual rights, and
an instrument for permitting said voting right to be separated from at least some of said residual rights of said underlying financial security to create a voting right security,
wherein ownership and control of said voting right security is tradable separate from ownership of said remaining residual rights of said underlying financial security to permit a value of said voting right security to be established in an open market.

7. A voting right security as claimed in claim 6 wherein said instrument is a transferable proxy contract.

8. A voting right security as claimed in claim 7 wherein said instrument is a fixed term transferable proxy contract that expires on a pre-specified date.

9. A voting right security as claimed in claim 7 wherein said instrument is a transferable proxy contract that expires after a pre-specified corporate event, such as an annual board meeting, take-over vote or a specific quarter's ex-dividend date.

10. A voting right security as claimed in claim 7 wherein said instrument is a transferable proxy contract that expires after a pre-specified number of days or weeks after a pre-specified corporate event, such as an annual board meeting, take-over vote or a specific quarter's ex-dividend date.

11. An index comprised of quantity derived as a indirect or direct measure of a value of at least one VRS as claimed in claim 6.
